(19) United States
(12) Patent Application Publication
(10) Pub. No.: US 2026/0317573 A1
(43) Pub. Date: Oct. 15, 2026

(54) INK JET RECORDING METHOD, INK JET RECORDING APPARATUS, AND SET OF AQUEOUS INK AND REACTION LIQUID

(71) Applicant: CANON KABUSHIKI KAISHA, Tokyo (JP)

(72) Inventors: HITOMI KAWAHARA, Kanagawa (JP); SATOSHI TAKEBAYASHI, Tokyo (JP); YUKO NEGISHI, Tokyo (JP)

(21) Appl. No.: 19/635,326

(22) Filed: Mar. 31, 2026

(30) Foreign Application Priority Data
Apr. 9, 2025 (JP) 2025-064523
Apr. 9, 2025 (JP) 2025-064524
Mar. 13, 2026 (JP) 2026-040931

(51) Int. Cl. C09D 11/54; B41J 2/155; B41M 3/00; C09D 11/40

(52) U.S. Cl. CPC C09D 11/54; B41J 2/155; B41M 3/001; C09D 11/40

(57) ABSTRACT

An ink jet recording method includes recording an image by performing application of an aqueous ink and an aqueous reaction liquid containing a reactant that reacts with the aqueous ink to a low to non-absorbing recording medium such that a time from the application of the reaction liquid to the recording medium to the application of the aqueous ink to the recording medium is 1800 ms or shorter using a one-pass method. The reaction liquid includes at least two types of nonionic surfactants each having an HLB value of 4 or greater and 16 or less with a difference of 1 or greater between a highest HLB value and a lowest HLB value of the at least two types of nonionic surfactants. A difference between a surface tension γᵢ of the aqueous ink and a surface tension γᵣ of the reaction liquid at 25° C. is 9 mN/m or less.

### BACKGROUND

### Field of the Technology

The present disclosure relates to an ink jet recording method, an ink jet recording apparatus, and a set of an aqueous ink and a reaction liquid.

### Description of the Related Art

In recent years, ink jet recording methods have been attracting attention even in commercial and industrial printing fields, such as for printing posters, wallpaper, and labels, because these methods can reduce the load on the environment and can handle small-lot printing that meets individual customer needs. In the commercial and industrial printing fields, high-resolution images are required to be formed on a variety of recording media. Such images are required to be recorded on, as an example of a recording medium, a recording medium that has low absorbency for an aqueous ink or a recording medium that barely absorbs an aqueous ink. Examples of the recording medium that has low absorbency for an aqueous ink (hereinafter, also referred to as “low-absorbing recording medium”) include a recording medium having a coating layer such as art paper or coated paper. Further, examples of the recording medium that barely absorbs an aqueous ink (hereinafter, also referred to as “non-absorbing recording medium”) include a plastic film.

The use of an aqueous ink containing a pigment (hereinafter, also referred to as “pigment ink”) has been examined from the viewpoints of the environment and the safety. A high-resolution image quality has been obtained by using a pigment ink on a recording medium that easily absorbs an aqueous ink without having a coating layer, such as plain paper. Meanwhile, in a case of the low-absorbing recording medium and the non-absorbing recording medium, since applied ink droplets are unlikely to permeate into the recording medium, adjacent ink droplets are applied before fixation of the ink due to the permeation barely occurs. As a result, ink droplets coalesce, which causes bleeding and irregularities, and thus the high-resolution image quality is difficult to obtain.

A reaction liquid (also referred to as a treatment liquid) containing polyvalent metal salts that react with components such as pigments in an ink to cause aggregation and thickening has been used to address the above-described disadvantages (see Japanese Patent Laid-Open Nos. 2024-076960, 2021-017005, and 2019-142068).

Meanwhile, an ink jet recording apparatus that has been used in the commercial and industrial printing fields is required to have improved productivity for convenience of customers. A drying step is essential for fixing an aqueous ink on a non-absorbing recording medium and a low-absorbing recording medium, but the drying step takes a long time when a reaction liquid and an ink are applied in large amounts in order to realize high color developability, which may result in reduction of the productivity. Therefore, there is a demand for an ink jet recording method that can realize high color developability with a small amount of ink.

### SUMMARY

Therefore, the present disclosure provides an ink jet recording method that enables recording of an image with high color developability on a non-absorbing recording medium and enables recording of an image having edges with suppressed irregularities on a low-absorbing recording medium, when the image is recorded by a one-pass method. In addition, the present disclosure further provides an ink jet recording apparatus and a set of an aqueous ink and a reaction liquid, which are used for this ink jet recording method.

That is, according to an aspect of the present disclosure, there is provided an ink jet recording method including: recording an image by performing application of an aqueous ink and an aqueous reaction liquid containing a reactant that reacts with the aqueous ink to a unit area of a recording medium having a water absorption amount of 10 mL/m² or less from a start of contact to 30 ms^{1/2} in a Bristow method such that a time from the application of the reaction liquid to the recording medium to the application of the aqueous ink to the recording medium is 1800 ms or shorter and such that an ink jet type ejection head and the recording medium are relatively scanned once, in which the reaction liquid contains a surfactant, the surfactant includes at least two types of nonionic surfactants each having an HLB value of 4 or greater and 16 or less, a difference between a highest HLB value and a lowest HLB value of the at least two types of nonionic surfactants is 1 or greater, the aqueous ink contains resin particles, and a difference γᵢ−γᵣ between a surface tension γᵢ of the aqueous ink and a surface tension γᵣ of the reaction liquid at 25° C. is 9 mN/m or less.

Features of the present disclosure will become apparent from the following description of embodiments with reference to the attached drawings. The following description of embodiments is described by way of example.

### BRIEF DESCRIPTION OF THE DRAWINGS

FIGS. 1A to 1C are schematic views for describing estimated states of surfactants in a reaction liquid applied to a non-absorbing recording medium.

FIGS. 2A to 2C are schematic views for describing estimated states of other surfactants in a reaction liquid applied to a non-absorbing recording medium.

FIG. 3 is a schematic view showing an embodiment of an ink jet recording apparatus according to the present disclosure.

FIG. 4 is a perspective view showing an example of a liquid applying device.

FIG. 5 is a cross-sectional perspective view showing an example of an ejection element substrate.

FIG. 6 is a schematic view showing an example of a liquid supply system.

FIG. 7 is a schematic view showing another example of a heating unit.

FIG. 8 is a schematic view showing another example of a fixing unit.

### DESCRIPTION OF THE EMBODIMENTS

Hereinafter, the present disclosure will be described in more detail with reference to suitable embodiments. In the present disclosure, when a compound is a salt, the salt is present by being dissociated in an ion state in an ink, but the expression “containing a salt” is used for convenience. Further, an ink jet aqueous ink and a reaction liquid will also be simply referred to as “ink” and “reaction liquid”. A physical property value is obtained at a normal temperature (25° C.), a normal pressure (1 atm=101,325 Pa), and a normal humidity (relative humidity of 50%) unless otherwise specified. Further, the term “unit” of a resin denotes a unit structure corresponding to one monomer unless otherwise specified. The term “(meth)acrylic acid” denotes “acrylic acid” or “methacrylic acid”, and the term “(meth)acrylate” denotes “acrylate” or “methacrylate”. Further, the unit “ms” denotes “millisecond”.

In recent years, with an increase in recording speed, a method of recording images by applying an ink to a recording medium using a so-called one-pass method has been examined in order to produce a large amount of printed materials in a short time. The one-pass method is a method of performing application of a liquid such as an ink or a reaction liquid to a unit area of a recording medium such that a recording head and the recording medium are relatively scanned once. The relative scanning performed once between the recording head and the recording medium includes, for example, a method in which the recording medium is conveyed in a direction intersecting a nozzle array direction of the recording head and an image is recorded by using a line head capable of recording an image over the entire width of the recording medium by performing scanning once. In the recording using the one-pass method, an image is recorded on the unit area of the recording medium by performing relative scanning only once between the recording head and the recording medium. The unit area can be set as an optional area, such as “one pixel”.

The present inventors have conducted recording of images on non-absorbing and low-absorbing recording media by the one-pass method using the reaction liquids and the inks suggested in Japanese Patent Laid-Open Nos. 2024-076960, 2021-017005, and 2019-142068. As a result, it is found that when the reaction liquid is applied to a recording medium prior to the ink, and the ink is applied to the recording medium using the one-pass method to record an image, the high color developability with a small amount of ink applied onto a non-absorbing recording medium is not realized to a level required by the present inventors. Further, it has also been found that a phenomenon in which the color of edges of solid areas of an image becomes darker than the color of the central portion (hereinafter, also referred to as “irregularities at edges of an image”) occurs on a low-absorbing recording medium.

The present inventors have conducted examination to realize the high color developability even with a small amount of ink applied to a non-absorbing recording medium using an ink jet recording apparatus when an image is recorded with a reaction liquid and an ink by applying the reaction liquid and the ink in this order using the one-pass method.

The one-pass method is required to record an image on a unit area such that a recording head and a recording medium are relatively scanned once. Therefore, in the image recording using the one-pass method, since dot arrangements cannot be superimposed by multiple passes when compared with image recording using a multipass method of recording an image by dividing a reaction liquid and an ink so that the reaction liquid and the ink are applied to the recording medium multiple times, white spots are likely to occur in the image, which may result in reduction of the color developability.

First, wet-spread of an ink is considered to be effective to reduce the amount of white spots in an image, and thus an image is recorded by preparing an ink with a decreased surface tension. As a result, a certain effect is obtained, but is not sufficient for a level required by the present inventors.

For this reason, the process of applying a reaction liquid and an ink to a recording medium is observed to clarify the mechanism by which white spots occur. As a result, it is found that the behavior of the ink differs between a portion to which the reaction liquid has been applied (portion covered with the reaction liquid) and a portion to which the reaction liquid has not been applied (portion uncovered with the reaction liquid) on the recording medium. In the portion covered with the reaction liquid, the ink aggregates at the location where the ink comes into contact with the reaction liquid after the application of the ink. Meanwhile, in the portion uncovered with the reaction liquid, the ink cannot aggregate at the location but coalesces with other ink dots after the application of the ink. That is, it is found that in the portion uncovered with the reaction liquid, white spots occur in the image because ink dots are not present at the location where the ink dots are expected to be disposed initially. Therefore, the present inventors have clarified that wet-spreading of a reaction liquid on the entire surface of a recording portion in a recording medium is more likely to obtain the effect of realizing high color developability than wet-spreading of an ink on the entire surface thereof.

Specific examples of a method of wet-spreading a reaction liquid on the entire surface of a recording portion in a recording medium include a method of increasing the amount of the reaction liquid to be applied. However, a drying load on the recorded material is increased, and as a result, the productivity is reduced. For this reason, there is a demand for a reaction liquid having low liquid interfacial energy and low solid-liquid interfacial energy so that even a small amount of reaction liquid efficiently wet-spread on the entire surface of a recording portion.

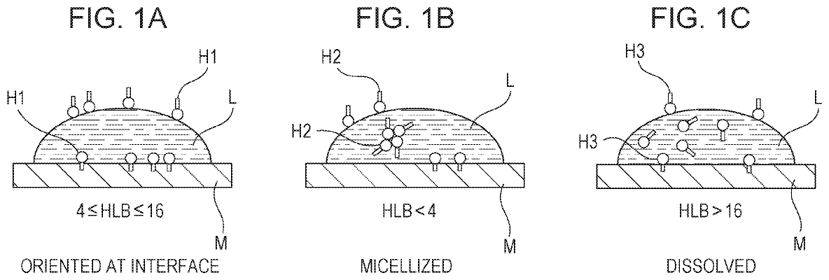

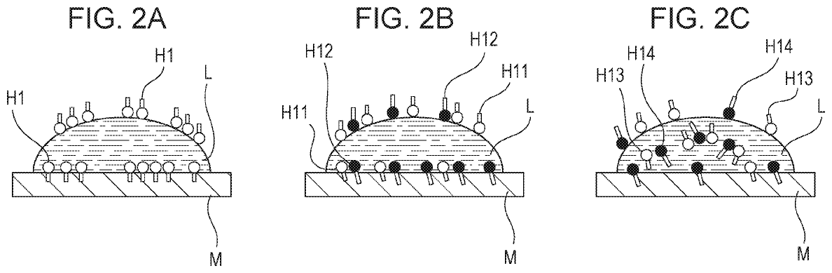

Next, the present inventors have examined a method of efficiently decreasing both the liquid interfacial energy and the solid-liquid interfacial energy by focusing on a surfactant in a reaction liquid. As a result of the examination conducted on various surfactants, it is found to be effective to use at least two types of nonionic surfactants each having an HLB value of 4 or greater and 16 or less with a difference of 1 or greater between the HLB values to efficiently decrease the liquid interfacial energy and the solid-liquid interfacial energy. The estimated mechanism by which an image with high color developability is obtained in a non-absorbing recording medium by using a reaction liquid containing at least two types of nonionic surfactants described above will be described below with reference to FIGS. 1A to 2C.

FIGS. 1A to 1C are schematic views for describing the estimated states of nonionic surfactants in a reaction liquid L applied to a non-absorbing recording medium M from the viewpoint of the HLB values. FIG. 1A is a schematic view when a nonionic surfactant H1 having an HLB value of 4 or greater and 16 or less is used, FIG. 1B is a schematic view when a nonionic surfactant H2 having an HLB value of less than 4 is used, and FIG. 1C is a schematic view when a nonionic surfactant H3 having an HLB value of greater than 16 is used. Further, FIGS. 2A to 2C are schematic views for describing the estimated states of nonionic surfactants each having an HLB value of 4 or greater and 16 or less in the reaction liquid L applied to the non-absorbing recording medium M from the viewpoint of the difference between HLB values. FIG. 2A is a schematic view when one type of nonionic surfactant H1 having an HLB value of 4 or greater and 16 or less is used. FIG. 2B is a schematic view when two types of nonionic surfactants H11 and H12 each having an HLB value of 4 or greater and 16 or less with a difference of 1 or greater between the HLB values are used. FIG. 2C is a schematic view when two types of nonionic surfactants H13 and H14 each having an HLB value of 4 or greater and 16 or less with a difference of less than 1 between the HLB values are used.

First, the nonionic surfactant H1 having an HLB value of 4 or greater and 16 or less is effective to use for decreasing the liquid interfacial energy (FIGS. 1A and 2A). It is considered that since the solubility of the nonionic surfactant H2 is low when the HLB value is less than 4, micellization is likely to occur in a solution, and thus the surfactant is unlikely to act at the interface (FIG. 1B). Further, it is considered that since the solubility of the nonionic surfactant H3 is high when the HLB value is greater than 16, the surfactant is dissolved in the solution, and thus the surfactant is unlikely to act at the interface (FIG. 1C).

Further, it is found to be effective to use at least two types of nonionic surfactants H11 and H12 with a difference of 1 or greater between the HLB values in order to decrease the solid-liquid interfacial energy at the same time (FIG. 2B). The present inventors consider the reason for this as follows. The nonionic surfactant H12 that is different and has a different HLB value from the nonionic surfactant H11 enters between molecules of the same nonionic surfactant H11, which increases the distance between the molecules of the same nonionic surfactant H11. In this manner, it is considered that the molecules of the nonionic surfactants are arranged at the interface and are likely to act to decrease the solid-liquid interfacial energy (FIG. 2B). Meanwhile, it is considered that when the difference in the HLB value between the two types of nonionic surfactants H13 and H14 is less than 1, since the nonionic surfactants are compatible with each other, the molecules thereof are unlikely to be oriented at the interface and thus are unlikely to act to decrease the solid-liquid interfacial energy (FIG. 2C). Therefore, the reaction liquid contains at least two types of nonionic surfactants each having an HLB value of 4 or greater and 16 or less with a difference of 1 or greater between the highest HLB value and the lowest HLB value. The present inventors have found the method of achieving high color developability even with a small amount of reaction liquid to be applied to a non-absorbing recording medium by using such a reaction liquid.

Meanwhile, there is a demand for recording of images not only on non-absorbing recording media but also on a variety of recording media in the commercial and industrial printing fields. Examples of such recording media include low-absorbing recording media. It is clarified that irregularities occur at edges of an image when a reaction liquid having low liquid interfacial energy and low solid-liquid interfacial energy is used on a low-absorbing recording medium. The reason for this is considered to be that a difference in surface tension between the reaction liquid and the ink is increased when the surface tension of the reaction liquid is decreased, and as a result, convection is likely to occur in the ink on the surface of the recording medium. Therefore, the occurrence of convection is suppressed by decreasing the surface tension of the ink and setting a difference (γᵢ−γᵣ) between a surface tension γᵢ of the ink and a surface tension γᵣ of the reaction liquid to 9 mN/m or less, and thus occurrence of irregularities at the edges of the image can be suppressed even when a reaction liquid with a decreased surface tension is used.

The above-described irregularities at edges of an image are a phenomenon that occurs specifically when a low-absorbing recording medium is used as a recording medium. In a case of plain paper or the like, which is a recording medium into which an ink or a reaction liquid permeates relatively quickly, the reaction liquid quickly permeates into the recording medium immediately after being applied to the recording medium, the ink applied to the recording medium comes into contact with the reaction liquid, and a pigment and an aqueous medium also permeate into the recording medium while the ink aggregates. Therefore, since convection does not occur in the ink on the surface of the recording medium, and the pigment barely moves, an image with suppressed irregularities can be obtained. Meanwhile, in a case of a non-absorbing recording medium that barely absorbs an ink and a reaction liquid, the reaction liquid barely permeates into the recording medium. For this reason, the reaction liquid and the ink come into sufficient contact with each other on the surface of the non-absorbing recording medium, and the ink sufficiently thickens. Therefore, convection is unlikely to occur in the ink, and thus irregularities are unlikely to occur at edges of an image.

Ink jet recording method, ink jet recording apparatus, and set of aqueous ink and reaction liquid

An ink jet recording method of the present disclosure (hereinafter, also simply referred to as “recording method”) is a method of recording an image by performing application of an ink and a reaction liquid to a unit area of a recording medium using an ink jet type ejection head such that the ejection head and the recording medium are relatively scanned once. Here, the time from the application of the reaction liquid to the recording medium to the application of the aqueous ink to the recording medium is 1800 ms or shorter. The ink jet recording method includes a reaction liquid applying step of applying the reaction liquid to the recording medium and an ink applying step of applying the ink to the recording medium such that the ink overlaps at least a part of the area on the recording medium to which the reaction liquid is applied. The reaction liquid contains a surfactant. The surfactant includes at least two types of nonionic surfactants each having an HLB value of 4 or greater and 16 or less, and a difference between the highest HLB value and the lowest HLB value of the at least two types of nonionic surfactants is 1 or greater. Further, the aqueous ink contains resin particles. In addition, the difference (γᵢ−γᵣ) between the surface tension γᵢ of the aqueous ink and the surface tension γᵣ of the reaction liquid at 25° C. is 9 mN/m or less. The recording medium has a water absorption amount of 10 mL/m² or less from the start of contact to 30 ms^{1/2} in a Bristow method.

Further, an ink jet recording apparatus of the present disclosure is a device used for an ink jet recording method of recording an image by ejecting an aqueous ink and a reaction liquid from an ink jet type ejection head and applying the aqueous ink and the reaction liquid to a recording medium. Further, the apparatus is suitably used for the above-described recording method. The ink jet recording method and the ink jet recording apparatus of the present disclosure are not required to cure an image by irradiation with activation energy rays or the like.

A set of the aqueous ink and the reaction liquid of the present disclosure is a set used for the ink jet recording method of ejecting the aqueous ink and the aqueous reaction liquid containing a reactant that reacts with the aqueous ink from an ejection head to record an image on the recording medium. Further, the set is suitably used for the above-described recording method. Examples of the form of the set include a set of a plurality of ink cartridges each independently accommodating a plurality of inks (reaction liquids) and an ink cartridge in a state of being integrally formed by combining a plurality of ink accommodating units each accommodating a plurality of inks (reaction liquids). The set of the present disclosure is not limited to the above-described forms as long as the set is configured to use a combination of inks and reaction liquids, and may be in any form.

### Ink Jet Recording Apparatus

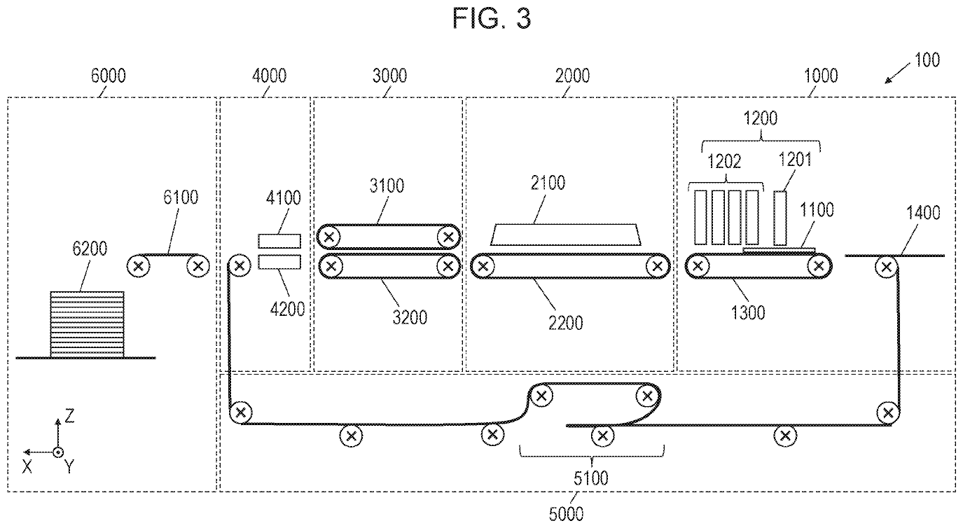

Hereinafter, the details of the ink jet recording apparatus will be described with reference to the accompanying drawings. FIG. 3 is a schematic view showing an embodiment of the ink jet recording apparatus according to the present disclosure. The ink jet recording apparatus of the present embodiment is an ink jet recording apparatus that records an image on a recording medium using an ink and a reaction liquid containing a reactant reacting with the ink. An X direction, a Y direction and a Z direction each denote a width direction (entire length direction), a depth direction and a height direction of the ink jet recording apparatus. The recording medium is conveyed in the X direction.

An ink jet recording apparatus 100 according to the embodiment shown in FIG. 3 is configured to include a recording unit 1000, a heating unit 2000, a fixing unit 3000, a cooling unit 4000, an inverting unit 5000, and a paper discharge unit 6000. In the recording unit 1000, various liquids are applied by a liquid applying device 1200 to a recording medium 1100 conveyed by a conveyance member 1300 from a feeding device 1400. In the heating unit 2000, the liquid applied to the recording medium 1100 is heated by a heating device 2100, and volatile components such as moisture in the liquid are evaporated to dry the recording medium 1100. In the fixing unit 3000, the recording medium 1100 is heated by bringing a fixing member 3100 into contact with an area of the recording medium 1100 where the liquid has been applied, to promote the fixation of an image to the recording medium 1100. Thereafter, the recording medium 1100 is cooled by a cooling member 4100 of the cooling unit 4000. In a case where an image is recorded on the rear surface of the recording medium after an image is recorded on the front surface (recording surface), first, the recording medium 1100 is inverted by an inverting device 5100 of the inverting unit 5000. Next, the recording medium 1100 is conveyed by a conveyance member 6100 of the paper discharge unit 6000 after an image is recorded on the rear surface of the recording medium 1100 in the same manner as the recording on the front surface, and the recording medium 1100 is stacked on and accommodated in a recording medium accommodating unit 6200.

### Recording Unit

The recording unit 1000 includes the liquid applying device 1200. The liquid applying device 1200 is configured to include a reaction liquid applying device 1201 and an ink applying device 1202. An ink jet type ejection head is used as the reaction liquid applying device 1201. The application of the reaction liquid using the reaction liquid applying device 1201 may be performed before or after the application of the ink as long as the reaction liquid can be brought into contact with the ink on the recording medium 1100. Here, the reaction liquid can be applied before the application of the ink in order to record a high-quality image on various recording media with different liquid absorption characteristics. An ink jet type ejection head (recording head) is used as the ink applying device 1202. Examples of an ejection method of the ejection head serving as the liquid applying device 1200 include a method of ejecting a liquid by causing film boiling in the liquid using an electrothermal converter to form air bubbles and a method of ejecting a liquid using an electromechanical converter. Among these, an ejection head that ejects a liquid by the action of thermal energy can be used. Such an ejection head is also referred to as a so-called thermal head.

In the recording method of the present disclosure, the time from the application of the reaction liquid to the recording medium to the application of the ink to the recording medium is 1800 ms or shorter. When the time from the application of the reaction liquid to the recording medium to the application of the ink to the recording medium is 1800 ms or shorter, irregularities at edges of an image are likely to be suppressed from occurring on the low-absorbing recording medium, and an image with high color developability is likely to be obtained on the non-absorbing recording medium. For the same reason, the time from the application of the reaction liquid to the recording medium to the application of the ink to the recording medium can be 550 ms or shorter, or 500 ms or shorter. Meanwhile, the time from the application of the reaction liquid to the recording medium to the application of the ink to the recording medium can be 40 ms or longer, or 50 ms or longer. The reaction liquid is applied to the non-absorbing recording medium and then wet-spreads on the recording medium with time. Therefore, the coverage of the reaction liquid increases as the time from the application of the reaction liquid to the recording medium to the application of the ink to the recording medium increases, which is advantageous for the color developability. When the time from the application of the reaction liquid to the recording medium to the application of the ink to the recording medium is 50 ms or longer, an image with higher color developability is likely to be obtained on the non-absorbing recording medium.

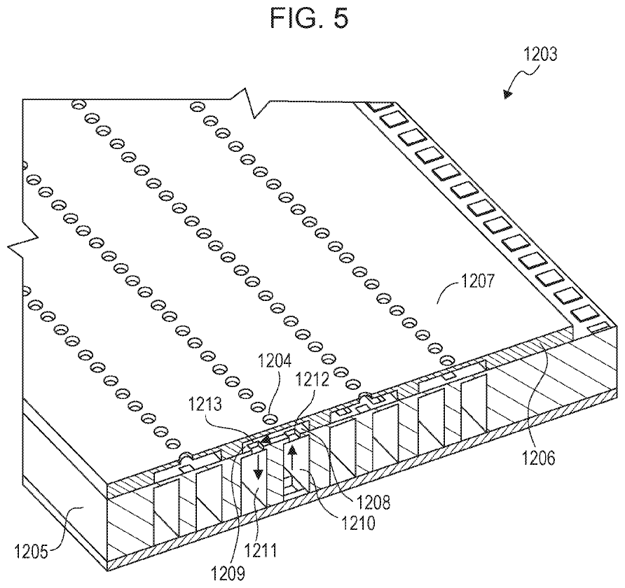

The liquid applying device 1200 is a line head extending in the Y direction, and ejection orifices are arranged in a range where an image recording area of the available recording medium with the maximum width is covered. The ejection head on the lower side (recording medium 1100 side) has an ejection orifice surface 1207 (FIG. 5) having an ejection orifice formed therein, and the ejection orifice surface faces the recording medium 1100 with an extremely small distance of several millimeters.

A plurality of ink applying devices 1202 may be provided to apply inks of each color to the recording medium 1100. For example, in a case where images of each color are recorded using a yellow ink, a magenta ink, a cyan ink, and a black ink, four ink applying devices 1202 for ejecting four types of inks described above are arranged side by side in the X direction. Hereinafter, the inks and the reaction liquids will also be collectively referred to as “liquid”.

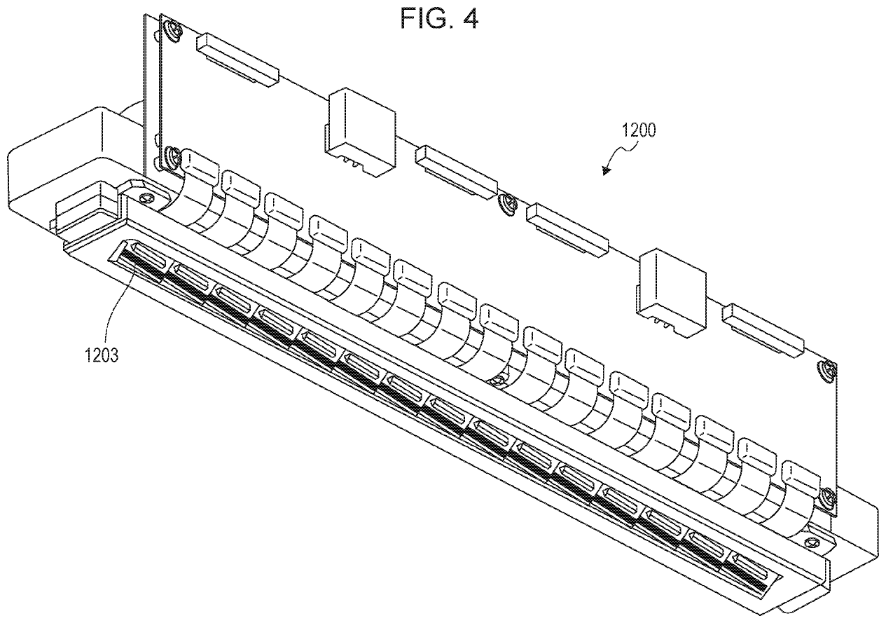

FIG. 4 is a perspective view showing an example of the liquid applying device. The liquid applying device 1200 shown in FIG. 4 is a line head, and a plurality of ejection element substrates 1203 each provided with an ejection orifice array are arranged in a straight line. A plurality of ejection orifice arrays are arranged in the ejection element substrate 1203.

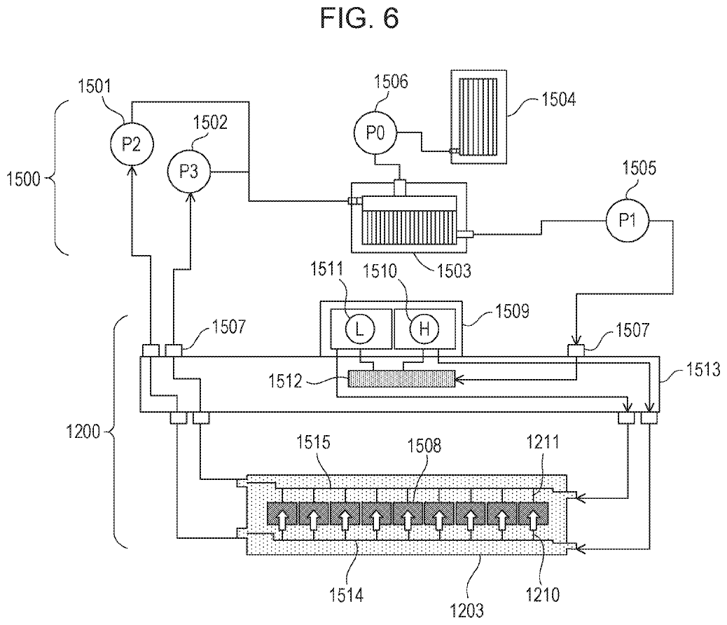

FIG. 5 is a cross-sectional perspective view showing an example of the ejection element substrate. The ejection element substrate 1203 shown in FIG. 5 includes an ejection orifice forming member 1206 having ejection orifices 1204 that are open and a substrate 1205 provided with an ejection element (not shown). A first channel 1208 and a second channel 1209 through which the liquid flows are formed by laminating the ejection orifice forming member 1206 and the substrate 1205. The first channel 1208 is an area from an inlet port 1212 into which the liquid flows from an inlet path 1210 to a portion (liquid chamber 1508 in FIG. 6) between the ejection orifice 1204 and the ejection element. Further, a second channel 1209 is an area from a portion (liquid chamber 1508 in FIG. 6) between the ejection orifice 1204 and the ejection element to an outlet port 1213 from which the liquid outflows to an outlet path 1211. For example, in a case where a difference in pressure is provided between the inlet port 1212 and the outlet port 1213 such that the inlet port 1212 is under a higher pressure and the outlet port 1213 is under a lower pressure, the liquid can be allowed to flow from a side where the pressure is higher to a side where the pressure is lower (in directions indicated by the arrows in FIG. 5). The liquid having passed through the inlet path 1210 and the outlet port 1212 flows into the first channel 1208. Further, the liquid having passed through the portion (liquid chamber 1508 in FIG. 6) between the ejection orifice 1204 and the ejection element flows into the outlet path 1211 after passing through the second channel 1209 and the outlet port 1213.

### Supply System

FIG. 6 is a schematic view showing an example of a supply system for the liquid such as the ink. A supply unit 1500 of the liquid applying device 1200 shown in FIG. 6 is configured to include a first circulation pump (high-pressure side) 1501, a first circulation pump (low-pressure side) 1502, a sub-tank 1503, and a second circulation pump 1505. The sub-tank 1503 connected to a main tank 1504 serving as a liquid accommodating unit includes an air communication port (not shown) and is capable of discharging air bubbles, which have been mixed into the liquid, to the outside of the circulation system. The sub-tank 1503 is also connected to a replenishing pump 1506. The liquid is consumed in the liquid applying device 1200 by ejecting (discharging) the liquid from the ejection orifice for recording an image, suction recovery, or the like. The replenishing pump 1506 transfers the liquid in an amount corresponding to the amount consumed from the main tank 1504 to the sub-tank 1503.

The first circulation pump (high-pressure side) 1501 and the first circulation pump (low-pressure side) 1502 cause the liquid inside the liquid applying device 1200 that has flowed from a connecting portion (inlet portion) 1507, to flow into the sub-tank 1503. Positive displacement pumps having a quantitative liquid feeding ability can be used as the first circulation pump (high-pressure side) 1501, the first circulation pump (low-pressure side) 1502, and the second circulation pump 1505. Examples of such positive displacement pumps include a tube pump, a gear pump, a diaphragm pump, and a syringe pump. The liquid can be allowed to flow from a common inlet path 1514 to a common outlet path 1515 by the first circulation pump (high-pressure side) 1501 and the first circulation pump (low-pressure side) 1502 when the ejection element substrate 1203 is driven.

A negative pressure control unit 1509 includes two pressure adjustment mechanisms with control pressures set to be different from each other. A pressure adjustment mechanism (high-pressure side) 1510 and a pressure adjustment mechanism (low-pressure side) 1511 are respectively connected to the common inlet path 1514 and the common outlet path 1515 in the ejection element substrate 1203 through a supply unit 1513 provided with a filter 1512 that removes foreign matter from the liquid. The ejection element substrate 1203 is provided with the common inlet path 1514, the common outlet path 1515, and an inlet path 1210 and an outlet path 1211 that communicate with a liquid chamber 1508 which is a portion between the ejection orifice 1204 and the ejection element (not shown). Since the inlet path 1210 and the outlet path 1211 respectively communicate with the common inlet path 1514 and the common outlet path 1515, a flow (indicated by the arrows in FIG. 6) in which a part of the liquid flows from the common inlet path 1514 to the common outlet path 1515 through the inside of the liquid chamber 1508 is generated. The arrows in FIG. 5 indicate the flow of the liquid inside the liquid chamber 1508. That is, the liquid inside the first channel 1208 flows into the second channel 1209 through a space between the ejection orifice 1204 and the ejection element as shown in FIG. 5.

As shown in FIG. 6, since the pressure adjustment mechanism (high-pressure side) 1510 is connected to the common inlet path 1514, and the pressure adjustment mechanism (low-pressure side) 1511 is connected to the common outlet path 1515, a difference in pressure occurs between the inlet path 1210 and the outlet path 1211. In this manner, a difference in pressure occurs even between the inlet port 1212 (FIG. 5) communicating with the inlet path 1210 and the outlet port 1213 (FIG. 5) communicating with the outlet path 1211. In a case where the liquid is allowed to flow using the difference in pressure between the inlet port 1212 and the outlet port 1213, the flow rate (mm/s) of the liquid can be controlled to 0.1 mm/s or greater to 10.0 mm/s or less.

### Conveyance System

As shown in FIG. 3, the recording unit 1000 is configured to include the liquid applying device 1200 and the conveyance member 1300 that conveys the recording medium 1100. The reaction liquid and the ink are applied by the liquid applying device 1200 to a desired position of the recording medium 1100 to be conveyed by the conveyance member 1300. Each liquid applying device receives an image signal of recording data and applies the reaction liquid and the ink required for each position. FIG. 3 shows the conveyance member 1300 as a form of a conveyance belt, but a spur, a conveyance cylinder, or the like may be used as the conveyance belt as long as these members have a function of conveying the recording medium 1100. A conveyance member capable of fixing the recording medium 1100 can be used as the conveyance member 1300 in order to increase the conveyance accuracy. Specific examples of a method of fixing the recording medium include a method of providing a hole in the conveyance member 1300 and suctioning the recording medium 1100 from the rear surface side thereof so that the recording medium 1100 is fixed and a method of forming the conveyance member 1300 using an appropriate material and electrostatically adsorbing the recording medium 1100 so that the recording medium 1100 is fixed.

### Heating Unit

As shown in FIG. 3, the heating unit 2000 is configured to include the heating device 2100 and a conveyance member 2200. The liquid component of an image is evaporated and dried by, using the heating device 2100, heating the recording medium 1100 where the reaction liquid and the ink have been applied and an image has been recorded while conveying the recording medium 1100 by the conveyance member 2200. A drying step of drying the ink by heating the recording medium to which the ink has been applied in a non-contact manner can be further provided between the ink applying step and the fixing step. When such a drying step is provided, deformation (cockling or curling) of the recording medium 1100 can be effectively suppressed.

The heating device 2100 may have any configuration as long as the recording medium 1100 can be heated, and various known devices of the related art, such as a hot air dryer and heater, can be used. Among these, a non-contact heater such as a heating wire or an infrared ray can be used from the viewpoint of the safety or energy efficiency. Further, when a mechanism that sends hot air by a built-in fan for blowing heated gas to the recording medium 1100 is used, the drying efficiency is likely to be enhanced, and image irregularities are more likely to be suppressed.

The method of heating the recording medium 1100 may be performed by heating the surface (recording surface (front surface)) side of the recording medium 1100 to which the reaction liquid and the ink have been applied, the rear surface side of the recording medium 1100, or both surfaces thereof. The conveyance member 2200 may have a function of heating the recording medium. FIG. 3 shows the conveyance member 2200 formed of the conveyance belt, but a spur, a conveyance cylinder, or the like may be used as long as these members have a function of conveying the recording medium 1100. From the viewpoint of suppressing deformation of the recording medium 1100 due to heating, a configuration in which the recording medium 1100 is conveyed while being in close contact with the conveyance member 2200 or a mechanism in which the recording medium is fixed to the conveyance member 2200 can be provided by blowing air from the heating unit 2000. Specific examples of a method of fixing the recording medium include a method of providing a hole in the conveyance member 2200 and suctioning the recording medium 1100 from the rear surface side thereof so that the recording medium 1100 is fixed and a method of forming the conveyance member 2200 using an appropriate material and electrostatically adsorbing the recording medium 1100 so that the recording medium 1100 is fixed.

From the viewpoint of quickly evaporating the liquid component and suppressing deformation of the recording medium 1100, the heating temperature can be set such that the recording medium is not over-heated. In consideration of the conveyance speed and the environment temperature, the temperature of a drying method can be set such that the recording medium has a desired temperature. Specifically, the temperature of the drying method (hot air or the like) can be set to 40° C. or higher to 100° C. or lower, or 60° C. or higher to 80° C. or lower. Further, in a case where the recording medium 1100 is heated by blowing heated gas, the wind speed can be set to 1 m/s or greater to 100 m/s or less. The temperature of the wind such as hot air can be measured by using a K-type thermocouple thermometer. Specific examples of the measuring device include “AD-5605H” (trade name, manufactured by A&D Company, Limited).

### Drying Step

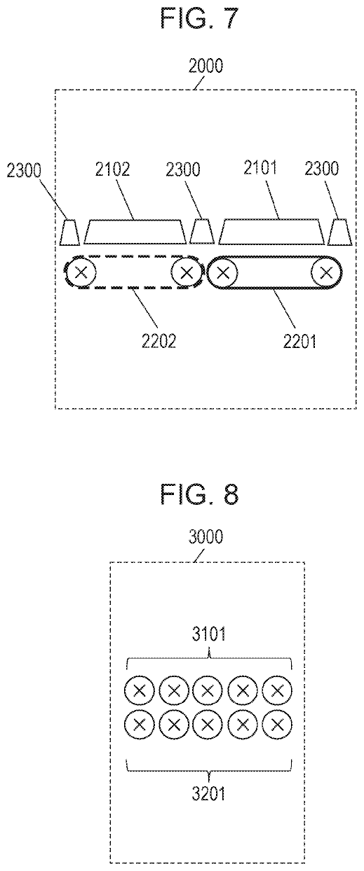

FIG. 7 is a schematic view showing another example of the heating unit. Here, a difference between this heating unit and the above-described heating unit shown in FIG. 3 will be described. The heating unit 2000 shown in FIG. 7 includes a first heating device 2101 and a second heating device 2102, and a first conveyance member 2201 and a second conveyance member 2202 respectively disposed opposite to the first heating device 2101 and the second heating device 2102.

The first conveyance member 2201 is not provided with a mechanism for suctioning and fixing the recording medium 1100. Further, the recording medium 1100 is conveyed by pressing the recording medium 1100 against the first conveyance member 2201 using hot air blown by the first heating device 2101. In this manner, the recording medium 1100 can be accurately transferred from the conveyance member 1300 (FIG. 3) to the first conveyance member 2201 and from the first conveyance member 2201 to the second conveyance member 2202. Further, a conveyance deviation caused by a slight difference in conveyance speed between the conveyance member 1300 (FIG. 3) and the first conveyance member 2201 can be reduced. Further, the recording medium 1100 is conveyed while being fixed to the second conveyance member 2202 by a suction mechanism (not shown) using, as the second conveyance member 2202, a conveyance belt provided with a hole into which gas can be transmitted.

An air knife 2300 is disposed between the conveyance member 1300 (FIG. 3) and the first conveyance member 2201, between the first conveyance member 2201 and the second conveyance member 2202, and between the second conveyance member 2202 and the conveyance member 3200 (FIG. 3). The air knife 2300 suppresses, using the wind pressure thereof, a leading edge of the conveyed recording medium 1100 from floating up. In this manner, collision of the leading edge of the recording medium 1100 with the first heating device 2101, the second heating device 2102 and the fixing member 3100 (FIG. 3) can be avoided, and occurrence of conveyance failure can be suppressed.

The first heating device 2101 and the second heating device 2102 may have the same configuration as the configuration of the heating device 2100 described above. The temperatures of the first heating device 2101 and the second heating device 2102 and the wind speeds thereof when the recording medium is heated by blowing heated gas may be same as or different from each other. Further, the recording medium may be heated by the first conveyance member 2201 and the second conveyance member 2202 as necessary.

### Fixing Unit

As shown in FIG. 3, the fixing unit 3000 is a contact type heating and pressurizing mechanism including the fixing member 3100 serving as a fixing belt, such as an endless belt, and the conveyance member 3200. In the fixing unit 3000, the recording medium 1100 is conveyed by the conveyance member 3200 and brought into contact with the fixing member 3100 in a state where the fixing member 3100 is pressurized against the recording medium 1100, and the liquids such as the reaction liquid, the ink, and the like applied to the recording medium 1100 are heated. In this manner, the image can be fixed to the recording medium 1100. In the recording medium 1100 on which the image has been recorded, the liquid components of the reaction liquid and the ink are evaporated by permeating into the recording medium 1100 or passing through the heating unit 2000, and the image is completed by being fixed to the recording medium 1100 by the fixing unit 3000. The recording medium 1100 is heated and pressurized in a state where the recording medium 1100 is sandwiched between the fixing member 3100 and the conveyance member 3200, and thus the image of the recording medium 1100 and the fixing member 3100 are brought into close contact, and the image is fixed to the recording medium 1100. When a liquid such as an ink containing resin particles and a coloring material is used, the resin particles are softened by being heated mainly by the fixing unit 3000 for film formation, and the coloring material can be bound onto the recording medium 1100.

Examples of a method of heating the fixing member 3100 include a method of heating the fixing member by providing a heat source such as a halogen heater inside a roller that drives the fixing member 3100 as a fixing belt. Further, other examples thereof include a method of heating the fixing member by providing a heat source such as an infrared heater at a site different from the fixing member 3100. In addition, these methods may be used in combination. The conveyance member 3200 may be heated as necessary. In consideration of the conveyance speed and the environment temperature, the temperature of the fixing member 3100 can be set such that the surface of the recording medium has a desired temperature. Specifically, the temperature of the fixing member 3100 can be set to 50° C. or higher and 120° C. or lower, or 60° C. or higher and 110° C. or lower. Both the temperature of the contact type heating and pressurizing mechanism (fixing member 3100) and the surface temperature of the recording medium immediately after the recording medium passes through the contact type heating and pressurizing mechanism can be measured using a radiation thermometer. The radiation thermometer may be installed in the vicinity of an end portion (terminal end) of the contact type heating and pressurizing mechanism. Specific examples of the radiation thermometer include “Radiation Thermometer IT-545S” (trade name, manufactured by Horiba, Ltd.).

In a case where the ink contains resin particles, the resin particles are likely to be softened and form a film, and thus the abrasion resistance of the image can be improved when the temperature of the fixing member 3100 is set to a temperature higher than or equal to the glass transition temperature of the resin particles in the ink. In a case where the ink contains wax particles, the temperature of the fixing member 3100 can be set to a temperature lower than the melting point of the wax constituting the wax particles. In this manner, the wax that is suppressed from being melted is likely to remain on the surface of the image, and thus the abrasion resistance of the image can be improved.

The nip pressure of the fixing member 3100 and conveyance member 3200, that is, the pressure applied to the recording medium when the recording medium passes through the contact type heating and pressurizing mechanism can be set to 10 Pa or greater and 1,000 Pa or less, 10 Pa or greater and 500 Pa or less, or 10 Pa or greater and 400 Pa or less. The time (nip time) required for the recording medium to pass through the contact type heating and pressurizing mechanism can be 0.25 seconds or longer and 5.0 second or shorter, 0.5 seconds or longer and 4.0 seconds or shorter, or 1.0 seconds or longer and 3.0 seconds or shorter.

FIG. 8 is a schematic view showing another example of the fixing unit. Here, a difference between this fixing unit and the above-described fixing unit shown in FIG. 3 will be described. The fixing unit 3000 shown in FIG. 8 is a contact type heating and pressurizing mechanism configured to include a plurality of fixing rollers 3101 and a plurality of conveyance members 3201 disposed opposite to the fixing rollers 3101. An image is fixed to the recording medium by allowing the recording medium 1100 to which the liquid such as the ink has been applied to pass through between the fixing roller 3101 and the conveyance member 3201. The degree of image fixation onto the recording medium can be adjusted by controlling the number of the fixing rollers 3101 and the conveyance members 3201, and the nip time, the temperature, and the pressure of the recording medium, which are affected by the fixing rollers and the conveyance members.

### Cooling Unit

The cooling unit 4000 is configured to include the cooling member 4100 and the conveyance member 4200 (FIG. 3). The cooling unit 4000 cools the recording medium 1100 that has been heated to a high temperature after passing through the heating unit 2000 and the fixing unit 3000. The cooling member 4100 may have any configuration as long as the recording medium 1100 can be cooled, and an air cooling method, a water cooling method, or the like can be used for cooling the recording medium. Among these, the recording medium can be cooled by blowing unheated gas from the viewpoints of the safety and the energy efficiency. Further, the cooling efficiency is likely to be enhanced when a mechanism that a fan for blowing gas to the recording medium 1100 is built-in and sends gas is used. In consideration of the conveyance speed and the environment temperature, the temperature of a cooling method can be set such that the image of the recording medium reaches a desired temperature. Specifically, the temperature of the cooling method (blowing air or the like) can be set to 20° C. or higher and 60° C. or lower, or 25° C. or higher and 50° C. or lower. In a case where the recording medium is cooled by blowing gas, the wind speed can be set to 1 m/s or greater and 100 m/s or less. When the recording medium is cooled under the above-described conditions, deformation of the recording medium 1100 to be stacked in a paper discharge unit 6000 described below and sticking (blocking) of the image to the recording medium can be suppressed.

### Inverting Unit

In a case where double-sided recording is performed, the recording medium 1100 is inverted by using the inverting unit 5000 (FIG. 3). The recording medium 1100 having the recording surface (front surface) on which the image has been recorded passes through the cooling unit 4000, branched, conveyed, and inverted by the inverting device 5100. The inverted recording medium 1100 is conveyed to the feeding device 1400 of the recording unit 1000 in a state where the liquid is applied to the rear surface (surface on a side opposite to the recording surface (front surface)) thereof.

### Paper Discharge Unit

The recording medium 1100 after image recording is accommodated in the paper discharge unit 6000 (FIG. 3). After one-sided or double-sided recording is performed, the recording medium 1100 having passed through the cooling unit 4000 is conveyed by the conveyance member 6100 and finally accommodated in the recording medium accommodating unit 6200 in a state of being stacked. In order to respectively accommodate different recorded materials, two or more recording medium accommodating units 6200 may be provided.

### Recording Medium

In the recording method and the recording apparatus of the present disclosure, a low-absorbing or non-absorbing recording medium (low to non-absorbing recording medium) is used. That is, a recording medium having a water absorption amount of 10 mL/m² or less from the start of contact to 30 ms^{1/2} is used in the Bristow method. In the present disclosure, the low-absorbing recording medium denotes a recording medium having a water absorption amount of 4 mL/m² or greater and 10 mL/m² or less from the start of contact to 30 ms^{1/2} in the Bristow method. Further, the non-absorbing recording medium denotes a recording medium having a water absorption amount of less than 4 mL/m² from the start of contact to 30 ms^{1/2} in the Bristow method. The Bristow method is described in “Paper and Paperboard, Liquid Absorbency Test Method” of JAPAN TAPPI Test Method No. 51 for Pulp and Paper. A recording medium (glossy paper, mat paper, or the like) for ink jet recording, which includes a coating layer (ink receiving layer) formed of inorganic particles or plain paper having no coating layer is an absorbing recording medium having a water absorption amount of greater than 10 mL/m².

Examples of the low to non-absorbing recording medium include a plastic film, a recording medium in which a plastic film is adhered to the recording surface of a base material, and a recording medium in which a resin coating layer is provided on the recording surface of a base material containing cellulose pulp. Among these, a plastic film can be used, and a recording medium in which a resin coating layer is provided on the recording surface of a base material containing cellulose pulp can also be used.

When the ink containing resin particles is applied to the non-absorbing recording medium, components such as water and a water-soluble organic solvents are volatilized, and as a result, the resin particles are concentrated. The fusion between the concentrated resin particles is promoted, and accordingly, the strength of an image to be record is improved. Meanwhile, even when the ink is applied to a recording medium having high absorbency for liquid components is applied, the fusion between the resin particles is unlikely to be promoted, and thus the strength of the image is not improved. Further, the recording medium in the present specification denotes not a transfer body but a recording medium which is a target on which an image is recorded as a recorded material.

### Reaction Liquid

The recording method of the present disclosure includes a reaction liquid applying step of applying an aqueous reaction liquid that contains a reactant reacting with an aqueous ink, to the recording medium. The reaction liquid applying step can be provided before the ink applying step of applying the aqueous ink to the recording medium. Hereinafter, each component and the like used in the reaction liquid will be described in detail.

### Reactant

The reaction liquid aggregates components (components containing an anionic group, such as a resin, a surfactant, and a self-dispersible pigment) in the ink by reacting with the ink when coming into contact with the ink, and contains a reactant. Due to the presence of the reactant, the state of presence of the components containing an anionic group in the ink is destabilized when the ink and the reactant come into contact with each other in the recording medium, and thus the aggregation of the ink can be promoted. Examples of the reactant include cationic components such as polyvalent metal ions and cationic resins, and organic acids. The reactant may be used alone or in combination of two or more kinds thereof.

Examples of the polyvalent metal ion constituting a polyvalent metal salt include divalent metal ions such as Ca²⁺, Cu²⁺, Ni²⁺, Mg²⁺, Sr²⁺, Ba²⁺, and Zn²⁺, and trivalent metal ions such as Fe³⁺, Cr³⁺, Y³⁺, and Al³⁺. In order for the reaction liquid to contain polyvalent metal ions, a water-soluble polyvalent metal salt (which may be a hydrate) formed by bonding a polyvalent metal ion and an anion can be used. Examples of the anion include inorganic anions such as Cl⁻, Br⁻, I⁻, ClO⁻, ClO₂⁻, ClO₃⁻, ClO₄⁻, NO₂⁻, NO₃⁻, SO₄²⁻, CO₃²⁻, HCO₃⁻, PO₄³⁻, HPO₄²⁻, and H₂PO₄⁻, and organic anions such as HCOO⁻, (COO⁻)₂, COOH(COO⁻), CH₃COO, C₂H₅COO⁻, CH₃CH(OH)COO⁻, C₂H₄(COO⁻)₂, C₆H₅COO⁻, C₆H₄(COO⁻)₂, and CH₃SO₃⁻.

In a case where the polyvalent metal ion is used as the reactant, the content (% by mass) thereof in terms of the polyvalent metal salt in the first reaction liquid can be 1.0% by mass or greater and 20.0% by mass or less with respect to the total mass of the reaction liquid. In the present specification, “content (% by mass) of the polyvalent metal salt” in the reaction liquid in a case where the polyvalent metal salt is a hydrate denotes “content (% by mass) of an anhydride of the polyvalent metal salt” excluding water as a hydrate.

Examples of the cationic resin include resins having structures of primary to tertiary amines and resins having structures of quaternary ammonium salts. Specific examples thereof include resins having structures of vinylamine, allylamine, vinylimidazole, vinylpyridine, dimethylaminoethyl methacrylate, ethyleneimine, guanidine, diallyldimethylammonium chloride, and an alkylamine/epichlorohydrin condensate. In order to increase the solubility in the reaction liquid, the cationic resin and an acidic compound can be used in combination or the cationic resin can be subjected to a quaternization treatment. When the cationic resin is used as the reactant, the content (% by mass) of the cationic resin in the reaction liquid can be 0.1% by mass or greater and 10.0% by mass or less with respect to the total mass of the reaction liquid.

The reaction liquid containing an organic acid has a buffer capacity in an acidic region (with a pH of less than 7.0 and suitably 2.0 to 5.0) and thus efficiently aggregates anionic groups of the components present in the ink in the form of an acid. Examples of the organic acid include a monocarboxylic acid such as formic acid, acetic acid, propionic acid, butyric acid, benzoic acid, glycolic acid, lactic acid, salicylic acid, pyrrolecarboxylic acid, furancarboxylic acid, picolinic acid, nicotinic acid, thiophenecarboxylic acid, levulinic acid, or coumaric acid and a salt thereof, a dicarboxylic acid such as oxalic acid, malonic acid, succinic acid, glutaric acid, adipic acid, maleic acid, fumaric acid, itaconic acid, sebacic acid, phthalic acid, malic acid, or tartaric acid, a salt thereof, and a hydrogen salt thereof, a tricarboxylic acid such as citric acid or trimellitic acid, a salt thereof, and a hydrogen salt thereof, and a tetracarboxylic acid such as pyromellitic acid, a salt thereof, and a hydrogen salt thereof. When the organic acid is used as the reactant, the content (% by mass) of the organic acid in the reaction liquid can be 1.0% by mass or greater and 50.0% by mass or less with respect to the total mass of the reaction liquid.

### Aqueous Medium

The reaction liquid is an aqueous reaction liquid containing at least water as an aqueous medium. The aqueous medium used in the reaction liquid can contain a water-soluble organic solvent described below, which can be contained in the ink. The content (% by mass) of water in the reaction liquid can be 65.0% by mass or greater and 98.0% by mass or less, or 70.0% by mass or greater and 95.0% by mass or less with respect to the total mass of the reaction liquid.

Examples of the water-soluble organic solvent that can be suitably contained in the reaction liquid include alkanediols such as 1,2-propanediol, 1,2-butanediol, 1,3-butanediol, 1,4-butanediol, 1,5-pentanediol, and 1,6-hexanediol, amino acids such as β-alanine and trimethylglycine, sulfonyl compounds such as bis(2-hydroxyethyl) sulfone, alkylene glycols such as triethylene glycol, tetraethylene glycol, tripropylene glycol, and polyethylene glycol having a number average molecular weight of about 200 to 1000, and saccharides such as sorbitol. The reaction liquid can contain one or two or more kinds of these water-soluble organic solvents. When the reaction liquid contains the water-soluble organic solvent, the content (% by mass) of the water-soluble organic solvent in the reaction liquid can be 0.5% by mass or greater and 30.0% by mass or less, or 1.0% by mass or greater and 25.0% by mass or less with respect to the total mass of the reaction liquid.

The above-described water-soluble organic solvent acts to decrease the surface tension of the liquid immediately after application to the recording medium, namely, immediately after the formation of the interface.

In the present disclosure, as a method of simulatively measuring the surface tension of the reaction liquid immediately after interface formation, a method of measuring the surface tension of a reaction liquid with a composition obtained by replacing a surfactant with water is used. In this case, the present inventors have found that the surface tension of a liquid obtained by replacing the surfactant in the reaction liquid with water at 25° C. can be set to 60 mN/m or greater. When the surface tension of the liquid obtained by replacing the surfactant in the reaction liquid with water at 25° C. is 60 mN/m or greater, the reaction liquid immediately after being applied to the recording medium is unlikely to permeate into the recording medium, and thus irregularities at edges of an image are more likely to be suppressed from occurring on the low-absorbing recording medium. The surface tension of the liquid obtained by replacing the surfactant in the reaction liquid with water is defined as a value of the surface tension of the liquid prepared by mixing the components in the reaction liquid except for the surfactant. The surface tension of the liquid obtained by replacing the surfactant in the reaction liquid with water at 25° C. is the static surface tension measured by the platinum plate method. Further, the surface tension of the liquid obtained by replacing the surfactant in the reaction liquid with water at 25° C. can be adjusted to 60 mN/m or greater by adjusting the type and the amount of the water-soluble organic solvent.

### Surfactant

The reaction liquid contains nonionic surfactants. The surfactants are molecules having hydrophobic moieties and hydrophilic moieties, and significantly decrease the static surface tension of the liquid. The surfactants to be contained in the reaction liquid include at least two types of nonionic surfactants each having an HLB value of 4 or greater and 16 or less with a difference of 1 or greater between the highest HLB value and the lowest HLB value among the at least two types of nonionic surfactants. Further, the upper limit of the difference in HLB value between the at least two types of nonionic surfactants can be 12 or less. From the viewpoint of easily recording an image with higher color developability on the non-absorbing recording medium, the at least two types of nonionic surfactants may have an HLB value of 8 or greater and 16 or less.

In the present specification, “HLB value” of the nonionic surfactant is a value determined by the Griffin method, and is calculated based on the formula: HLB value=20×(formula weight of hydrophilic group in surfactant)/(molecular weight of surfactant). The HLB value determined by the Griffin method is a physical property value indicating the degree of hydrophilicity and lipophilicity of the nonionic surfactant, which is in range of 0 to 20. The lipophilicity increases as the HLB value decreases, and the hydrophilicity increases as the HLB value increases.

Examples of the surfactant include a hydrocarbon-based surfactant, a fluorinated surfactant, and a silicone-based surfactant. Examples of the hydrocarbon-based surfactant include an ethylene oxide adduct of acetylene glycol, polyethylene glycol alkyl ether, and a polyoxyethylene polyoxypropylene block polymer. Examples of the fluorinated surfactant include a perfluoroalkyl ethylene oxide adduct. Examples of the silicone-based surfactant include a polyether-modified siloxane compound.

Among these, the reaction liquid can contain the hydrocarbon-based surfactant and the silicone-based surfactant. When the reaction liquid contains the hydrocarbon-based surfactant and the silicone-based surfactant, the color developability of an image is more likely to be enhanced in the non-absorbing recording medium. From this viewpoint, the at least two types of the nonionic surfactants each having an HLB value of 4 or greater and 16 or less with a difference of 1 or greater between the highest HLB value and the lowest HLB value can include the silicone-based surfactant and the hydrocarbon-based surfactant. Further, the at least two types of nonionic surfactants can be a combination of the silicone-based surfactant and the hydrocarbon-based surfactant. In addition, the at least two types of nonionic surfactants includes a first type of nonionic surfactant and a second type of nonionic surfactant, and a mass ratio of a content of the first type of nonionic surfactant to a content of the second type of nonionic surfactant in the reaction liquid is 1/5 or greater and 5/1 or less. In other words, the mass ratio of the content of one (the first type of nonionic surfactant) of the at least two types of nonionic surfactants to the content of the other nonionic surfactant (the second type of nonionic surfactant) can be 0.2 or greater and 5.0 or less. When the mass ratio between the contents of the at least two types of nonionic surfactants in the reaction liquid is set to 1/5 or greater and 5/1 or less, the effect of decreasing the solid-liquid interfacial energy between the reaction liquid and the recording medium is likely to be obtained, and the color developability of the image on the non-absorbing recording medium is more likely to be enhanced. Further, when the reaction liquid contains three or more types of nonionic surfactants, the mass ratio between the contents of at least two types of nonionic surfactants in the reaction liquid can be 1/5 or greater and 5/1 or less, and the mass ratio between the contents of all two types of nonionic surfactants in the reaction liquid can be 1/5 or greater and 5/1 or less.

The reaction liquid can further contain various surfactants (other surfactants) in addition to the nonionic surfactant having an HLB value of 4 or greater and 16 or less. Examples of the other surfactants include an anionic surfactant, a cationic surfactant, and an amphoteric surfactant. Further, the other surfactants may be a hydrocarbon-based surfactant, a fluorinated surfactant, a silicone-based surfactant, and the like, each having an HLB value that is outside the above-described range. The total content (% by mass) of the surfactants (the nonionic surfactants and the other surfactants) in the reaction liquid can be 0.1% by mass or greater and 5.0% by mass or less with respect to the total mass of the reaction liquid. Further, the proportion of the content of the at least two types of surfactants in the total content of the surfactants in the reaction liquid can be 80.0% by mass or greater and 100.0% by mass or less, or 90.0% by mass or greater and 100.0% by mass or less.

### Other Components

The reaction liquid may contain various other components as necessary. Examples of the other components include those that are the same as the other components described below, which can be contained in the ink.

### Surface Tension of Reaction Liquid

The reaction liquid is an aqueous reaction liquid to be applied to the ink jet method. Therefore, the physical property values thereof can be appropriately controlled from the viewpoint of the reliability. Specifically, the surface tension γᵣ of the reaction liquid at 25° C. can be 20 mN/m or greater and 60 mN/m or less, or 30 mN/m or less. When the surface tension of the reaction liquid at 25° C. is 30 mN/m or less, the reaction liquid is likely to wet-spread on the recording medium, the coverage of the reaction liquid on the recording medium is likely to increase, and thus the color developability is likely to be sufficiently obtained. As the surface tension of the reaction liquid, a value measured by the platinum plate method at 25° C. can be employed.

### Other Physical Properties of Reaction Liquid

Further, the viscosity of the reaction liquid at 25° C. can be 1.0 mPa·s or greater and 10.0 mPa·s or less. The pH of the reaction liquid at 25° C. can be 5.0 or greater and 9.5 or less, or 6.0 or greater and 9.0 or less.

### Ink

The first ink used for the recording method of the present disclosure is an ink jet aqueous ink. Hereinafter, each component constituting the ink will be described in detail.

### Coloring Material

The ink can contain a coloring material. A pigment or a dye can be used as the coloring material. Among these, the ink can contain a pigment. The content (% by mass) of the coloring material in the ink can be 0.1% by mass or greater and 15.0% by mass or less, or 1.0% by mass or greater and 10.0% by mass or less with respect to the total mass of the ink.

Specific examples of the pigment include an inorganic pigment such as carbon black or titanium oxide, and an organic pigment such as azo, phthalocyanine, quinacridone, isoindolinone, imidazolone, diketopyrrolopyrrole, or dioxazine. The pigment may be used alone or in combination of two or more kinds thereof.

As a pigment dispersion method, a resin-dispersed pigment formed of a resin as a dispersant or a self-dispersible pigment in which a hydrophilic group is bonded to the particle surface of the pigment can be used. Further, a resin-bonded pigment in which an organic group containing a resin is chemically bonded to the particle surface of the pigment, a microcapsule pigment in which the particle surface of the pigment is coated with a resin, or the like can be used. Among these, pigments using different dispersion methods can also be used in combination. Among these, a resin-dispersed pigment in which a resin as a dispersant is physically adsorbed on the particle surface of the pigment can be used without using the resin-bonded pigment or the microcapsule pigment.

A resin dispersant that can disperse the pigment in an aqueous medium using the action of an anionic group can be used as the resin dispersant for dispersing the pigment in an aqueous medium. Resins containing an anionic group can be used as the resin dispersant, and the following resins and particularly water-soluble resins among the resins can be used. The mass ratio of the content (% by mass) of the pigment in the ink to the content of the resin dispersant can be 0.3 times or greater and 10.0 times or less.

As the self-dispersible pigment, a pigment in which an anionic group such as a carboxylic acid group, a sulfonic acid group, or a phosphonic acid group is bonded to the particle surface of the pigment directly or through another atomic group (—R—) can be used. The anionic group may be of an acid type or a salt type and may be in a dissociable state partially or entirely in a case where the anionic group is of a salt type. Examples of the cation serving as a counter ion include an alkali metal cation, ammonium, and organic ammonium in the case where the anionic group is of a salt type. Specific examples of the other atomic groups (—R—) include a linear or branched alkylene group having 1 to 12 carbon atoms, an arylene group such as a phenylene group or a naphthylene group, a carbonyl group, an imino group, an amide group, a sulfonyl group, an ester group, and an ether group. Further, a group obtained by combining these groups may be used.

A dye containing an anionic group can be used as the dye. Specific examples of the dye include dyes such as azo, triphenylmethane, (aza) phthalocyanine, xanthene, and anthrapyridone. The dye may be used alone or in combination of two or more kinds thereof. The coloring material can be a pigment and suitably a resin-dispersed pigment or a self-dispersible pigment.

### Resin Particles

The ink contains the resin particles. When the ink contains the resin particles, the ink in contact with the reaction liquid is likely to be thickened, and irregularities at the edges of the image are likely to be suppressed from occurring on the low-absorbing recording medium. Examples of the resin constituting the resin particles include an acrylic resin, a urethane-based resin, an olefin-based resin, and a polyester resin.

The content (% by mass) of the resin particles in the ink can be 0.1% by mass or greater and 15.0% by mass or less, or 1.0% by mass or greater and 10.0% by mass or less with respect to the total mass of the ink. The mass ratio of the content (% by mass) of the resin particles to the content (% by mass) of the pigment in the aqueous ink can be 1.5 times or greater or 1.7 times or greater, and 10.0 times or less. When the mass ratio of the content of the resin particles to the content of the pigment in the ink is 1.5 times or greater, the ink in contact with the reaction liquid is likely to be thickened, and irregularities at the edges of the image are likely to be suppressed from occurring on the low-absorbing recording medium. The resin particles are present in the ink in a dispersion state, that is, in the form of a resin emulsion. Resin particles containing no coloring materials can be used.

In the present specification, “resin particle” refers to a resin that is not dissolved in an aqueous medium constituting the ink and specifically denotes a resin that can be present in an aqueous medium in a state of forming a particle having a particle diameter which can be measured by a dynamic light scattering method. Meanwhile, “water-soluble resin” refers to a resin that can be dissolved in an aqueous medium constituting the ink and specifically denotes a resin that can be present in an aqueous medium in a state of forming a particle having a particle diameter which can be measured by a dynamic light scattering method. “Resin particle” can be referred to as “water-dispersible resin (water-insoluble resin)”.

The acid value of the resin constituting the resin particles can be 5 mg KOH/g or greater and 100 mg KOH/g or less. The weight-average molecular weight of the resin constituting the resin particles can be 1,000 or greater and 3,000,000 or less, or 100,000 or greater and 3,000,000 or less. The volume-based cumulative 50% particle diameter (D50) of the resin particles measured by the dynamic light scattering method can be 50 nm or greater and 500 nm or less. The volume-based cumulative 50% particle diameter of the resin particles is the particle diameter that is 50% in a case of integration from the small particle diameter side based on the total volume of the measured particles in the particle diameter integration curve. The volume-based cumulative 50% particle diameter of the resin particles can be measured with a particle size analyzer using a dynamic light scattering method under the measurement conditions described above. The glass transition temperature of the resin particles can be 40° C. or higher and 120° C. or lower, or 50° C. or higher and 100° C. or lower. The glass transition temperature (° C.) of the resin particles can be measured by using a differential scanning calorimeter (DSC). The resin particle is not required to contain a coloring material.

### Other Resins

The ink can contain other resins in addition to the above-described resin particles. An image with improved abrasion resistance can be recorded by using the ink containing a resin. (i) The resin can be added to the ink to stabilize the dispersion state of the pigment, that is, to serve as a resin dispersant or an assistant thereof. (ii) Further, the resin can be added to the ink to improve various characteristics of an image to be recorded.

The content (% by mass) of the resin in the ink can be 0.1% by mass or greater and 20.0% by mass or less, or 0.5% by mass or greater and 15.0% by mass or less with respect to the total mass of the ink. Examples of the form of the resin include a block copolymer, a random copolymer, a graft copolymer, and a combination thereof. Further, the resin may be a water-soluble resin that can be dissolved in an aqueous medium, and may be used alone or in combination of two or more kinds thereof.

### Composition of Resin

Examples of the resin include an acrylic resin, a urethane-based resin, and an olefin-based resin. Among these, an acrylic resin or a urethane-based resin can be used, and an acrylic resin formed of a unit derived from (meth)acrylic acid or (meth)acrylate can be suitably used.

An acrylic resin having a hydrophilic unit and a hydrophobic unit as constituent units can be used as the acrylic resin. Among such examples, a resin having a hydrophilic unit derived from (meth)acrylic acid and a hydrophobic unit derived from at least one monomer selected from the group consisting of a monomer having an aromatic ring and a (meth)acrylic acid ester-based monomer can be used.

Particularly, a resin having a hydrophilic unit derived from (meth)acrylic acid and a hydrophobic unit derived from at least one monomer selected from the group consisting of styrene and α-methylstyrene can be used. These resins are likely to interact with a pigment and thus can be suitably used as a resin dispersant for dispersing the pigment.

The hydrophilic unit is a unit containing a hydrophilic group such as an anionic group. The hydrophilic unit can be formed, for example, by polymerizing a hydrophilic monomer containing a hydrophilic group. Specific examples of the hydrophilic monomer containing a hydrophilic group include an acidic monomer containing a carboxylic acid group such as (meth)acrylic acid, itaconic acid, maleic acid, or fumaric acid, and an anionic monomer such as an anhydride or a salt of the acidic monomer. Examples of a cation constituting a salt of the acidic monomer include an ion such as lithium, sodium, potassium, ammonium, or organic ammonium. The hydrophobic unit is a unit containing no hydrophilic group such as an anionic group. The hydrophobic unit can be formed, for example, by containing no hydrophilic group such as an anionic group and polymerizing a hydrophobic monomer. Specific examples of the hydrophobic monomer include a monomer having an aromatic ring such as styrene, α-methylstyrene, or benzyl (meth)acrylate, and a (meth)acrylic acid ester-based monomer such as methyl (meth)acrylate, butyl (meth)acrylate, or 2-ethylhexyl (meth)acrylate.

The urethane-based resin can be obtained, for example, by reacting a polyisocyanate with a polyol. Further, the urethane-based resin may be obtained by further reacting a chain extender. Examples of the olefin-based resin include polyethylene and polypropylene.

### Properties of Resin

In the present specification, the expression “resin is water-soluble” denotes that the resin is present in an aqueous medium in a state where a particle having a particle diameter that can be measured by a dynamic light scattering method is not formed in a case where the resin is neutralized with an alkali equivalent to the acid value. Whether the resin is water-soluble can be determined by the following method. First, a liquid (resin solid content: 10% by mass) containing a resin neutralized with an alkali (sodium hydroxide, potassium hydroxide, or the like) equivalent to the acid value is prepared. Next, the prepared liquid is diluted to 10 times (on a volume basis) with pure water to prepare a sample solution.

Further, in a case where the particle diameter of the resin in the sample solution is measured by a dynamic light scattering method, the resin can be determined as a water-soluble resin when a particle having a particle diameter is not measured. The measurement here can be performed by setting SetZero to 30 seconds, the number of times of measurement to three times and the measurement time to 180 seconds. Further, a particle size analyzer (for example, trade name “UPA-EX150”, manufactured by NIKKISO CO., Ltd.) using a dynamic light scattering method can be used as a particle size distribution measuring device.

It goes without saying that the particle size distribution measuring device to be used, the measurement conditions, and the like are not limited to the description above.

The acid value of the water-soluble resin can be 100 mg KOH/g or greater and 250 mg KOH/g or less. The weight-average molecular weight of the water-soluble resin can be 3,000 or greater and 15,000 or less.

### Aqueous Medium

The ink is an aqueous ink containing at least water as an aqueous medium. The ink can contain water or an aqueous medium which is a mixed solvent of water and a water-soluble organic solvent. Deionized water or ion exchange water can be used as water. The content (% by mass) of water in the aqueous ink can be 50.0% by mass or greater and 95.0% by mass or less with respect to the total mass of the ink.

Further, the content (% by mass) of the water-soluble organic solvent in the aqueous ink can be 3.0% by mass or greater and 45.0% by mass or less with respect to the total mass of the ink. Any water-soluble organic solvent that can be used in an ink jet ink such as alcohols, (poly)alkylene glycols, glycol ethers, nitrogen-containing solvents, or sulfur-containing solvents can be used as the water-soluble organic solvent. The water-soluble organic solvent may be used alone or in combination of two or more kinds thereof.

### Other Components

The ink may contain various other components as necessary. Examples of the other components include various additives such as a defoaming agent, a surfactant, a pH adjuster, a viscosity adjuster, a rust inhibitor, a preservative, an antifungal agent, an antioxidant, and a reducing inhibitor. Here, the ink can contain no reactant to be contained in the reaction liquid.

### Surface Tension of Ink

The ink is an aqueous ink to be applied to the ink jet method. Therefore, the physical property values thereof can be appropriately controlled from the viewpoint of the reliability. Specifically, the surface tension of the ink at 25° C. can be 32 mN/m or less, or 28 mN/m or less. When the surface tension of the ink at 25° C. can be 28 mN/m or less, the wettability of the ink is increased, and thus an image with higher color developability is likely to be obtained. The surface tension of the ink at 25° C. can be 18 mN/m or greater. As the surface tension of the ink, a value measured by the platinum plate method at 25° C. can be employed.

### Other Physical Properties of Ink

Further, the viscosity of the ink at 25° C. can be 1.0 mPa·s or greater and 10.0 mPa·s or less. The pH of the ink at 25° C. can be 7.0 or greater and 9.5 or less, or 8.0 or greater and 9.5 or less.

### Relationship Between Surface Tension of Reaction Liquid and Surface Tension of Ink

A difference (γᵢ−γᵣ) between the surface tension γᵢ of the aqueous ink and the surface tension γᵣ of the reaction liquid at 25° C. is 9 mN/m or less. When the difference between the surface tension of the ink and the surface tension of the reaction liquid is greater than 9 mN/m, convection of the ink is likely to occur on the surface of the recording medium, and irregularities at the edges of an image occur on the low-absorbing recording medium. From the viewpoint of more easily suppressing irregularities at the edges of an image from occurring on the low-absorbing recording medium, the difference (γᵢ−γᵣ) between the surface tension γᵢ of the ink and the surface tension γᵣ of the reaction liquid can be 5 mN/m or less.

Average Particle Diameter of Particles when Reaction Liquid and Ink are Mixed

In the present disclosure, as a method of simulatively measuring the reactivity caused by the contact between the reaction liquid and the ink, a method of measuring the average particle diameter of particles in a mixed liquid formed by mixing the reaction liquid with the ink at a mass ratio of 1:1 is employed. The particles in the mixed liquid formed by mixing the reaction liquid with the ink at a mass ratio of 1:1 are aggregates of the components in the ink, generated by the contact between the ink and the reaction liquid. The average particle diameter of particles in a mixed liquid obtained by mixing the reaction liquid and the ink at a mass ratio of 1:1 can be 7 μm or greater. When the average particle diameter thereof is 7 μm or greater, since ink droplets applied adjacent to the reaction liquid are unlikely to flow into the reaction liquid side, the effect of suppressing granularity of the image is likely to be enhanced. Further, the average particle diameter of the particles in the mixed liquid obtained by mixing the reaction liquid and the ink at a mass ratio of 1:1 can be 15 μm or greater and 40 μm or less. Further, when the average particle diameter of the particles is 15 μm or greater, the occurrence of convection in the ink on the surface of the recording medium is suppressed, and the effect of suppressing the granularity of the image as well as the effect of suppressing the occurrence of irregularities at the edges of the image can be obtained. When the average particle diameter thereof is 40 μm or less, the effect of suppressing the granularity of the image is likely to be enhanced while the spread of ink dots is maintained. Further, when the average particle diameter thereof is 40 μm or less, since the ink brought into contact with the reaction liquid aggregates in a wetted and spread state to some extent, white spots and crack-like unevenness are unlikely to occur, and thus the color developability is improved. The average particle diameter can be measured with a laser diffraction type particle size distribution measuring device using the mixed liquid obtained by mixing the reaction liquid and the ink at a mass ratio of 1:1 as a sample.

The average particle diameter of the particles in the mixed liquid obtained by mixing the reaction liquid and the ink at a mass ratio of 1:1 can be adjusted, for example, by the content and the type of reactant to be contained in the reaction liquid, the content, the molecular weight, and the cationic degree of the cationic resin that can be used as the reactant, and the valence of the organic acid that can be used as the reactant. Further, when the reaction liquid is made constant to have a predetermined composition, the average particle diameter thereof can also be adjusted by the ink used in combination with the reaction liquid. For example, when the ink contains a self-dispersible pigment, the average particle diameter thereof can be adjusted by the density and the like of the carboxylic acid groups that are bonded to the particle surface of the pigment directly or via other atomic groups. Further, when the ink contains a resin-dispersed pigment, the average particle diameter thereof can be adjusted by the acid value, the content, and the like of the resin dispersant to be used. Further, when the ink contains resin particles and a water-soluble resin, the average particle diameter thereof can be adjusted by the acid value and the content of the resin particles, and the acid value and the content of the water-soluble resin. Further, the average particle diameter thereof can also be adjusted by the surfactant. Examples of a method of increasing the average particle diameter thereof include a method of increasing the density of carboxylic acid groups in a self-dispersible pigment, a method of increasing the acid value of a resin dispersant in a resin dispersed pigment, and a method of increasing the acid value of resin particles or a water-soluble resin.

### EXAMPLES

Hereinafter, the present disclosure will be described in more detail with reference to examples and comparative examples. The present disclosure is not limited to the following examples unless the gist thereof is overstepped. In regard to the component amount, “parts” and “%” are on a mass basis unless otherwise specified.

### Preparation of Reaction Liquid

The components (unit: %) listed in the upper rows of Table 1 (Table 1-1 and Table 1-2) were mixed, sufficiently stirred, and filtered under pressure through a cellulose acetate filter (manufactured by ADVANTEC CO., LTD.) having a pore size of 3.0 μm, thereby preparing each reaction liquid. In Table 1, “silicone-based surfactant” is a surfactant having a chemical structure represented by Formula (1). A silicone-based surfactant 1 is a nonionic surfactant in which x in Formula (1) represents 11, and the HLB value is 11. A silicone-based surfactant 2 is a nonionic surfactant in which x in Formula (1) represents 12, and the HLB value is 12. “Hydrocarbon-based surfactant” is listed in Table 2. These hydrocarbon-based surfactants are nonionic surfactants. “PROXEL GXL(S)” is the trade name of a preservative (manufactured by Arch Chemical, Inc.). When the reaction liquid contains three types of nonionic surfactants, “difference between HLB values of two types of surfactants” in Table 1 is a difference between the highest HLB value and the lowest HLB value among the three types of nonionic surfactants. In such a case, “mass ratio between two types of surfactants” in Table 1 is the value of the largest mass ratio between the contents of two types of nonionic surfactants among three types of nonionic surfactants.

The surface tension of a sample prepared by mixing the components listed in Table 1 except for the surfactants (the silicone-based surfactants and the hydrocarbon-based surfactants) and stirring the mixture was measured as the surface tension of the liquid obtained by replacing the surfactant in the reaction liquid with water at 25° C. The surface tension of a sample prepared by mixing all the components listed in Table 1 and stirring the mixture was measured as the surface tension of the reaction liquid. The surface tension is a value measured by the platinum plate method using an automatic surface tension meter (DY-300 type: manufactured by Kyowa Interface Science Co., Ltd.).

TABLE 1-1
Compositions and characteristics of reaction liquids

| | Reaction liquid | | | | | | | | |
|---|---|---|---|---|---|---|---|---|---|
| | 1 | 2 | 3 | 4 | 5 | 6 | 7 | 8 | 9 |
| Magnesium sulfate | 6.00 | 6.00 | 6.00 | 6.00 | 6.00 | 6.00 | 6.00 | 6.00 | 6.00 |
| SURFYNOL DF-110 D | | | | | | | | | |
| SURFYNOL 420 | | 1.00 | | | | | | 1.00 | |
| SURFYNOL 440 | | | | | | | 1.00 | | |
| ACETYLENOL E60 | | | | 0.50 | | | | | |
| NONION P-208 | | | | | | | | | |
| ACETYLENOL E100 | 1.00 | | | 0.50 | 0.50 | 0.50 | | 1.00 | |
| ACETYLENOL E200 | | | 1.00 | | | | | | |
| SURFYNOL 485 | | | | | | | | | |
| Silicone-based surfactant 1 | 1.00 | 1.00 | 1.00 | | 0.30 | 0.25 | 1.00 | | 0.10 |
| Silicone-based surfactant 2 | | | | 1.00 | | | | | 0.10 |
| Propylene glycol | 6.00 | 6.00 | 6.00 | 6.00 | 6.00 | 6.00 | 6.00 | 6.00 | 6.00 |
| PROXEL GXL(S) | 0.02 | 0.02 | 0.02 | 0.02 | 0.02 | 0.02 | 0.02 | 0.02 | 0.02 |
| Ion exchange water | 85.98 | 85.98 | 85.98 | 85.98 | 87.18 | 87.23 | 85.98 | 85.98 | 87.78 |
| Surface tension [mN/m] | 22 | 23 | 25 | 23 | 30 | 31 | 23 | 27 | 24 |
| Difference between HLB values | 2 | 7 | 5 | 1 | 2 | 2 | 3 | 9 | 1 |
| of two types of surfactants | | | | | | | | | |
| Mass ratio between contents | 1.0 | 1.0 | 1.0 | 2.0 | 0.6 | 0.5 | 1.0 | 1.0 | 1.0 |
| of two types of surfactants | | | | | | | | | |
| Surface tension of liquid | 64 | 64 | 64 | 64 | 64 | 64 | 64 | 64 | 64 |
| obtained by replacing | | | | | | | | | |
| surfactant with water [mN/m] | | | | | | | | | |

TABLE 1-2
Compositions and characteristics of reaction liquids

| | Reaction liquid | | | | | | | | | |
|---|---|---|---|---|---|---|---|---|---|---|
| | 10 | 11 | 12 | 13 | 14 | 15 | 16 | 17 | 18 | 19 |
| Magnesium sulfate | 6.00 | 6.00 | 6.00 | 6.00 | 6.00 | 6.00 | 6.00 | 6.00 | 6.00 | 6.00 |
| SURFYNOL DF-110 D | | | | | | | 1.00 | | | |
| SURFYNOL 420 | | | | | | | | | | |
| SURFYNOL 440 | | | | | | | | | | |
| ACETYLENOL E60 | | | | | | | | | 1.00 | 0.70 |
| NONION P-208 | | | | | | | | | | 0.30 |
| ACETYLENOL E100 | 1.00 | 1.00 | 1.00 | 1.00 | 1.00 | | 1.00 | | | |
| ACETYLENOL E200 | | | | | | | | | | |
| SURFYNOL 485 | | | | | | | | 1.00 | | |
| Silicone-based surfactant 1 | 0.20 | 0.10 | 1.00 | 1.00 | | 1.00 | | 1.00 | | |
| Silicone-based surfactant 2 | | | | | | | | | 1.00 | 1.00 |
| Propylene glycol | 6.00 | 6.00 | 10.00 | 20.00 | 6.00 | 6.00 | 6.00 | 6.00 | 6.00 | 6.00 |
| PROXEL GXL(S) | 0.02 | 0.02 | 0.02 | 0.02 | 0.02 | 0.02 | 0.02 | 0.02 | 0.02 | 0.02 |
| Ion exchange water | 86.78 | 86.88 | 81.98 | 71.98 | 86.98 | 86.98 | 85.98 | 85.98 | 85.98 | 85.98 |
| Surface tension [mN/m] | 24 | 26 | 22 | 22 | 28 | 24 | 28 | 25 | 23 | 25 |
| Difference between HLB values | 2 | 2 | 2 | 2 | — | — | 10 | 6 | 0 | 0 |
| of two types of surfactants | | | | | | | | | | |
| Mass ratio between contents | 0.2 | 0.1 | 1.0 | 1.0 | — | — | 1.0 | 1.0 | 1.0 | 3.3 |
| of two types of surfactants | | | | | | | | | | |
| Surface tension of liquid | 64 | 64 | 60 | 54 | 64 | 64 | 64 | 64 | 64 | 64 |
| obtained by replacing | | | | | | | | | | |
| surfactant with water [mN/m] | | | | | | | | | | |

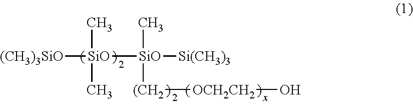

TABLE 2
Types and characteristics of hydrocarbon-based surfactants

| | | HLB |
|---|---|---|
| Trade name | Manufacturer | value |
| SURFYNOL DF-110 D | Manufactured by Nissin Chemical Co., Ltd. | 3 |
| SURFYNOL 420 | Manufactured by Nissin Chemical Co., Ltd. | 4 |
| SURFYNOL 440 | Manufactured by Nissin Chemical Co., Ltd. | 8 |
| ACETYLENOL E60 | Manufactured by Kawaken Fine Chemicals Co., Ltd. | 12 |
| NONION P-208 | Manufactured by NOF Corporation | 12 |
| ACETYLENOL E100 | Manufactured by Kawaken Fine Chemicals Co., Ltd. | 13 |
| ACETYLENOL E200 | Manufactured by Kawaken Fine Chemicals Co., Ltd. | 16 |
| SURFYNOL 485 | Manufactured by Nissin Chemical Co., Ltd. | 17 |
| NIKKOL BO-50V | Manufactured by Nikko Chemicals Co., Ltd. | 18 |

### Preparation of Pigment Dispersion Liquid

### Pigment Dispersion Liquid

A styrene-ethyl acrylate-acrylic acid copolymer (resin 1) with an acid value of 150 mg KOH/g and a weight-average molecular weight of 8000 was prepared. 20.0 parts of the resin 1 was neutralized with potassium hydroxide in an amount equimolar to the acid value thereof, and an appropriate amount of pure water was added thereto to prepare an aqueous solution of the resin 1 in which the content of the resin (solid content) was 20.0%, 15.0 parts of a pigment (C.I. Pigment Red 122), 30.0 parts of the aqueous solution of the resin 1, and 55.0 parts of pure water were mixed to obtain a mixture. The obtained mixture and 200 parts of zirconia beads having a diameter of 0.3 mm were placed in a batch type vertical sand mill (manufactured by AIMEX Co., Ltd.) and dispersed for 5 hours while being cooled with water. Coarse particles were removed by centrifugation, and the resultant was filtered under pressure through a cellulose acetate filter (manufactured by ADVANTEC CO., LTD.) having a pore size of 3.0 μm, thereby preparing a pigment dispersion liquid in which the content of the pigment was 15.0% and the content of the resin dispersant (resin 1) was 6.0%.

### Production of Resin Particles

### Resin Particles

74.0 parts of ion exchange water and 0.2 parts of potassium persulfate were placed in a four-necked flask provided with a stirrer, a reflux cooling device, and a nitrogen gas introduction pipe, and mixed. Further, 24.0 parts of ethyl methacrylate, 1.5 parts of methacrylic acid, and 0.3 parts of a reactive surfactant were mixed to prepare an emulsion. As the reactive surfactant, “ADEKA REASOAP ER20” (trade name, manufactured by ADEKA Corporation, nonionic surfactant, addition mole number of ethylene oxide group: 20) was used.

The prepared emulsion was added dropwise to the four-necked flask over one hour in a nitrogen atmosphere, and the polymerization reaction was performed for 2 hours while the mixture was stirred at 80° C. The mixture was cooled to 25° C., and ion exchange water and an aqueous solution containing potassium hydroxide in an amount equimolar to the acid value of the resin particles were added thereto, thereby preparing an aqueous dispersion liquid of resin particles 1 in which the content of the resin particles (solid content) was 40.0%.

### <Preparation of Aqueous Solution of Water-Soluble Resin>

### (Aqueous Solution of Water-Soluble Resin)

The styrene-ethyl acrylate-acrylic acid copolymer (resin 1) with an acid value of 150 mg KOH/g and a weight-average molecular weight of 8000, which is the same copolymer used in the preparation of the pigment dispersion liquid described above, was prepared. 20.0 parts of the resin 1 was neutralized with potassium hydroxide in an amount equimolar to the acid value thereof, and an appropriate amount of pure water was added thereto to prepare an aqueous solution of the resin 1 in which the content of the resin (solid content) was 20.0%.

### Preparation of Ink

The components (unit: %) listed in the upper rows of Table 3 (Table 3-1 and Table 3-2) were mixed, sufficiently stirred, and filtered under pressure through a cellulose acetate filter (manufactured by ADVANTEC CO., LTD.) having a pore size of 3.0 μm, thereby preparing each ink. In Table 3, “ACETYLENOL E60” is the trade name of a nonionic surfactant (acetylene glycol ethylene oxide adduct: manufactured by Kawaken Fine Chemicals Co., Ltd.), and “NIKKOL BO-50V” is the trade name of a nonionic surfactant (polyoxyethylene oleyl ether; manufactured by Nikko Chemicals Co., Ltd.) as listed even in Table 2. “Silicone-based surfactant 1” is a nonionic surfactant in which x in Formula (1) represents 11, and the HLB value is 11 as described above, which is a surfactant having a chemical structure in which x in Formula (1) represents 11 and the HLB value is 11. As the surface tension of the ink listed in the lower rows of Table 3, the surface tension of a sample prepared by mixing all the components listed in Table 3 and stirring the mixture was measured. The surface tension is a value measured by the platinum plate method using an automatic surface tension meter (DY-300 type: manufactured by Kyowa Interface Science Co., Ltd.). Further, “value of B/P (times)” listed in the lower rows of Table 3 is a mass ratio of a content B of the resin particles in the ink to a content P of the pigment in the ink.

TABLE 3-1
Compositions and characteristics of ink

| | Ink | | | | |
|---|---|---|---|---|---|
| | 1 | 2 | 3 | 4 | 5 |
| Pigment dispersion liquid 1 | 26.70 | 26.70 | 26.70 | 26.70 | 26.70 |
| Aqueous dispersion liquid of resin particles 1 | 20.00 | 20.00 | 20.00 | 20.00 | 20.00 |
| Aqueous solution of resin 1 | | | | | |
| Silicone-based surfactant 1 | 1.00 | 0.30 | 0.75 | 0.50 | 0.80 |
| ACETYLENOL E60 | | | | | |
| NIKKOL BO-50V | | | | | |
| 1,2-Butanediol | 19.00 | 19.00 | 19.00 | 19.00 | 19.00 |
| 1,2-Hexanediol | 1.00 | 1.00 | 1.00 | 1.00 | 1.00 |
| PROXEL GXL(S) | 0.02 | 0.02 | 0.02 | 0.02 | 0.02 |
| Ion exchange water | 32.28 | 32.98 | 32.53 | 32.78 | 32.48 |
| Surface tension [mN/m] | 26 | 31 | 28 | 29 | 27 |
| Content P of pigment [%] | 4.0 | 4.0 | 4.0 | 4.0 | 4.0 |
| Content B of resin particles 1 [%] | 8.0 | 8.0 | 8.0 | 8.0 | 8.0 |
| Value of B/P [times] | 2.0 | 2.0 | 2.0 | 2.0 | 2.0 |

TABLE 3-2
Compositions and characteristics of ink

| | Ink | | | | |
|---|---|---|---|---|---|
| | 6 | 7 | 8 | 9 | 10 |
| Pigment dispersion liquid 1 | 26.70 | 26.70 | 26.70 | 26.70 | 26.70 |
| Aqueous dispersion liquid of resin particles 1 | 20.00 | 15.00 | 10.00 | 20.00 | 20.00 |
| Aqueous solution of resin 1 | | | | | |
| Silicone-based surfactant 1 | 0.70 | 1.00 | 1.00 | 1.00 | 1.00 |
| ACETYLENOL E60 | | | | | |
| NIKKOL BO-50V | | | | 0.50 | 1.00 |
| 1,2-Butanediol | 19.00 | 19.00 | 19.00 | 19.00 | 19.00 |
| 1,2-Hexanediol | 1.00 | 1.00 | 1.00 | 1.00 | 1.00 |
| PROXEL GXL(S) | 0.02 | 0.02 | 0.02 | 0.02 | 0.02 |
| Ion exchange water | 32.58 | 37.28 | 42.28 | 31.78 | 31.28 |
| Surface tension [mN/m] | 28 | 24 | 24 | 26 | 26 |
| Content P of pigment [%] | 4.0 | 4.0 | 4.0 | 4.0 | 4.0 |
| Content B of resin particles 1 [%] | 8.0 | 6.0 | 4.0 | 8.0 | 8.0 |
| Value of B/P [times] | 2.0 | 1.5 | 1.0 | 2.0 | 2.0 |

TABLE 3-3
Compositions and characteristics of ink

| | Ink | | | | |
|---|---|---|---|---|---|
| | 11 | 12 | 13 | 14 | 15 |
| Pigment dispersion liquid 1 | 26.70 | 26.70 | 26.70 | 26.70 | 26.70 |
| Aqueous dispersion liquid of resin particles 1 | 20.00 | 20.00 | 20.00 | 0.00 | 20.00 |
| Aqueous solution of resin 1 | | 2.50 | 3.00 | | |
| Silicone-based surfactant 1 | 1.00 | 1.00 | 1.00 | | |
| ACETYLENOL E60 | | | | 1.00 | 3.00 |
| NIKKOL BO-50V | 0.10 | | | | |
| 1,2-Butanediol | 19.00 | 19.00 | 19.00 | 19.00 | 19.00 |
| 1,2-Hexanediol | 1.00 | 1.00 | 1.00 | 1.00 | 1.00 |
| PROXEL GXL(S) | 0.02 | 0.02 | 0.02 | 0.02 | 0.02 |
| Ion exchange water | 32.18 | 29.78 | 29.28 | 52.28 | 32.98 |
| Surface tension [mN/m] | 26 | 26 | 26 | 20 | 32 |
| Content P of pigment [%] | 4.0 | 4.0 | 4.0 | 4.0 | 4.0 |
| Content B of resin particles 1 [%] | 8.0 | 8.0 | 6.0 | 0.0 | 8.0 |
| Value of B/P [times] | 2.0 | 2.0 | 2.0 | 0.0 | 2.0 |

### Measurement of Physical Property Value

Average Particle Diameter when Mixing

The average particle diameter of particles in a mixed liquid obtained by mixing the reaction liquid and the ink, used in combination in the following examples and comparative examples, at a mass ratio of 1:1 was measured as follows. First, the reaction liquid was added to the ink at the above-described mass ratio to obtain a mixed liquid. Further, the mixed liquid was stirred for 90 seconds at a memory 2.5 using a magnetic stirrer (trade name “HS-360”, manufactured by AS ONE Corporation), and the average particle diameter of the particles was measured. The average particle diameter was measured by using a laser diffraction type particle size distribution measuring device (trade name “SALD-2300”, manufactured by Shimadzu Corporaiton).

### Recording Medium

The following recording media 1 to 3 were prepared.
Recording medium 1: trade name “PETWH50 PAT 1 9K” (manufactured by Lintec Corporation, material: PET, water absorption amount of 0 mL/m² or greater and 3 mL/m² or less from start of contact to 30 ms^{1/2} in Bristow method)
Recording medium 2: trade name “ART PW8E WHITE” (manufactured by Lintec Corporation, water absorption amount of 4 mL/m² or greater and 10 mL/m² or less from start of contact to 30 ms^{1/2} in Bristow method)
Recording medium 3: trade name “High-quality 55PW8K Blue” (manufactured by Lintec Corporation, water absorption amount of greater than 10 mL/m² from start of contact to 30 ms^{1/2} in Bristow method)

### Evaluation

The recording conditions are listed in Table 4. The reaction liquids and the inks of the types listed on the left side in Table 4 were combined to be used as sets of the reaction liquids and the inks. The reaction liquid applying device 1201 and the ink applying device 1202 of the ink jet recording apparatus 100 having the configuration shown in FIG. 3 were respectively filled with the reaction liquid and the ink constituting the set. Images were recorded using the ink jet recording apparatus 100 under the evaluation conditions listed in Table 4. Specifically, the reaction liquid and the ink were applied in this order to the recording medium by one-pass method, hot air at 80° C. was blown to the recording medium from the heating device 2100 to dry the images, and thus the images used for each evaluation were recorded. In the ink jet recording apparatus 100 used in the present examples, an image recorded under a condition that 4.0 ng of one ink droplet is applied to a unit area of 1/1200 inches×1/1200 inches is defined as a recording duty of 100%. In Table 4, “application time difference (ms) between reaction liquid and ink” is the time from the application of the reaction liquid to the recording medium to the application of the ink to the recording medium. In the present disclosure, “AA”, “A” and “B” are in acceptable levels, and “C” is in an unacceptable level according to the evaluation criteria in each item described below. The evaluation results are listed on the right side in Table 4.

### Color Developability

The reaction liquid (20% recording duty) and the ink (in 10% increments within a range of 40% to 110% recording duty) were applied in this order to the recording medium 1 to record a halftone image. L*, a*, and b* in the L*a*b* color system defined by International Commission on Illumination (CIE) were measured with a fluorescence spectrodensitometer (trade name “FD-7”, manufactured by KONICA MINOLTA, INC.) from the recorded halftone image using a light source D50 at a viewing angle of 2 degrees, an incident angle of 45 degrees, and a reflection angle of 0 degrees. The chroma (C*) was calculated from the obtained measured values using the following equation. Further, in Reference Examples 1 and 2, the color developability was evaluated using the recording medium 3 in place of the recording medium 1 as listed in Table 4.

C*={(a*)²+(b*)²}^{1/2}

The color developability of the image was evaluated based on the amount (μg/cm²) of ink applied, which was required to obtain an image in which C* was 75, according to the evaluation criteria described below.
A: The required amount of ink was less than 500 μg/cm².
B: The required amount of ink was 500 μg/cm² or greater and less than 720 μg/cm².
C: The required amount of ink was less than 720 μg/cm² or greater.

### Irregularities at Edges of Image

The reaction liquid (24% recording duty) and the ink (160% recording duty) were applied in this order to the recording medium 2 to record an image. With this recorded image, irregularities at the edges of the image were evaluated from a distance at which the irregularities at the edges of the image were visually recognizable according to the following evaluation criteria. Further, in Reference Examples 1 and 2, the irregularities at the edges of the image were evaluated using the recording medium 3 in place of the recording medium 2 as listed in Table 4.
AA: Irregularities were not visually recognizable at a distance of 30 cm from the recorded material.
A: Irregularities were visually recognizable at a distance of 30 cm from the recorded material, but were not visually recognizable at a distance of 40 cm from the recorded material.
B: Irregularities were visually recognizable at a distance of 40 cm from the recorded material, but were not visually recognizable at a distance of 50 cm from the recorded material.
C: Irregularities were visually recognizable even at a distance of 50 cm from the recorded material.

### (Granularity)

The image recorded for the evaluation of the irregularities at the edges of the image was observed from distances of 20 cm, 30 cm, and 50 cm, and the granularity of the image was evaluated according to the following evaluation criteria. Further, in Reference Examples 1 and 2, the granularity was evaluated using the recording medium 3 in place of the recording medium 2 as listed in Table 4.
AA: Roughness due to granularity was not found and the image was visually recognized as being uniform even when the image was observed from a distance of 20 cm.
A: Roughness due to granularity was found when the image was observed from a distance of 20 cm, but roughness due to granularity was not found and the image was visually recognized as being uniform when the image was observed from a distance of 30 cm.
B: Roughness due to granularity was found when the image was observed from a distance of 30 cm, but roughness due to granularity was not found and the image was visually recognized as being uniform when the image was observed from a distance of 50 cm.

TABLE 4
Evaluation conditions and evaluation results

| | | Set of reaction liquid and ink | | | | Evaluation condition | | | | |
|---|---|---|---|---|---|---|---|---|---|---|
| | | | | | Average particle | | Application | | | |
| | | | | | diameter when | | time | | | |
| | | | | Surface tension of | reaction liquid | | difference | Evaluation result | | |
| | | | | ink − surface | and ink were | | between | | Irregular- | |
| | | | | tension of | mixed at mass | | reaction | Color | ities at | |
| | | Reaction | | reaction liquid | ratio of 1:1 | Recording | liquid and | develop- | edges of | Granu- |
| | | liquid | Ink | [mN/m] | [μm] | medium | ink [ms] | ability | image | larity |
| Example | 1 | 1 | 1 | 4 | 20 | 1, 2 | 300 | A | AA | AA |
| | 2 | 2 | 1 | 3 | 20 | 1, 2 | 300 | B | AA | AA |
| | 3 | 3 | 1 | 1 | 20 | 1, 2 | 300 | A | AA | AA |
| | 4 | 1 | 2 | 9 | 19 | 1, 2 | 300 | B | A | AA |
| | 5 | 4 | 1 | 3 | 20 | 1, 2 | 300 | A | AA | AA |
| | 6 | 1 | 1 | 4 | 20 | 1, 2 | 1800 | B | A | AA |
| | 7 | 5 | 1 | −4 | 20 | 1, 2 | 300 | A | AA | AA |
| | 8 | 6 | 1 | −5 | 20 | 1, 2 | 300 | B | AA | AA |
| | 9 | 1 | 3 | 6 | 20 | 1, 2 | 300 | A | A | AA |
| | 10 | 1 | 4 | 7 | 20 | 1, 2 | 300 | B | A | AA |
| | 11 | 7 | 1 | 3 | 20 | 1.2 | 300 | A | AA | AA |
| | 12 | 8 | 1 | −1 | 20 | 1, 2 | 300 | B | AA | AA |
| | 13 | 9 | 1 | 2 | 21 | 1, 2 | 300 | B | AA | AA |
| | 14 | 10 | 1 | 2 | 22 | 1, 2 | 300 | A | AA | AA |
| | 15 | 11 | 1 | 0 | 22 | 1, 2 | 300 | B | AA | AA |
| | 16 | 12 | 1 | 4 | 20 | 1, 2 | 300 | A | AA | AA |
| | 17 | 13 | 1 | 4 | 19 | 1, 2 | 300 | A | A | AA |
| | 18 | 1 | 5 | 5 | 20 | 1, 2 | 300 | A | AA | AA |
| | 19 | 1 | 6 | 6 | 20 | 1, 2 | 300 | A | A | AA |
| | 20 | 1 | 7 | 2 | 20 | 1, 2 | 300 | A | AA | AA |
| | 21 | 1 | 8 | 2 | 20 | 1, 2 | 300 | A | A | AA |
| | 22 | 1 | 1 | 4 | 20 | 1, 2 | 50 | A | AA | AA |
| | 23 | 1 | 1 | 4 | 20 | 1, 2 | 40 | B | AA | AA |
| | 24 | 1 | 1 | 4 | 20 | 1, 2 | 500 | A | AA | AA |
| | 25 | 1 | 1 | 4 | 20 | 1, 2 | 550 | B | AA | AA |
| | 26 | 1 | 9 | 4 | 7 | 1, 2 | 300 | A | A | A |
| | 27 | 1 | 10 | 4 | 5 | 1, 2 | 300 | A | A | B |
| | 28 | 1 | 11 | 4 | 15 | 1, 2 | 300 | A | AA | AA |
| | 29 | 1 | 12 | 4 | 40 | 1, 2 | 300 | A | AA | AA |
| | 30 | 1 | 13 | 4 | 45 | 1, 2 | 300 | B | AA | A |
| Comparative | 1 | 14 | 1 | −2 | 20 | 1, 2 | 300 | C | AA | AA |
| Example | 2 | 15 | 1 | 2 | 16 | 1, 2 | 300 | C | AA | AA |
| | 3 | 16 | 1 | −2 | 20 | 1, 2 | 300 | C | AA | AA |
| | 4 | 17 | 1 | 1 | 20 | 1, 2 | 300 | C | AA | AA |
| | 5 | 18 | 1 | 3 | 20 | 1, 2 | 300 | C | AA | AA |
| | 6 | 19 | 1 | 1 | 20 | 1, 2 | 300 | C | AA | AA |
| | 7 | 1 | 1 | 4 | 20 | 1, 2 | 2000 | B | C | AA |
| | 8 | 1 | 14 | −2 | 6 | 1, 2 | 300 | B | C | B |
| | 9 | 1 | 15 | 10 | 18 | 1.2 | 300 | A | C | AA |
| Reference | 1 | 1 | 1 | 4 | 20 | 3 | 300 | C | AA | AA |
| Example | 2 | 14 | 1 | −2 | 20 | 3 | 300 | C | AA | AA |

According to the present disclosure, it is possible to provide an ink jet recording method that enables recording of an image with high color developability on a non-absorbing recording medium and enables recording of an image having edges with suppressed irregularities on a low-absorbing recording medium, when the image is recorded by the one-pass method. In addition, according to the present disclosure, it is also possible to provide an ink jet recording apparatus and a set of an aqueous ink and a reaction liquid, which are used for this ink jet recording method.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-064523, filed Apr. 9, 2025, No. 2025-064524, filed Apr. 9, 2025, and No. 2026-040931, filed Mar. 13, 2026, which are hereby incorporated by reference herein in their entirety.

What is claimed is:

1. An ink jet recording method comprising:
recording an image by performing application of an aqueous ink and an aqueous reaction liquid containing a reactant that reacts with the aqueous ink to a unit area of a recording medium having a water absorption amount of 10 mL/m² or less from a start of contact to 30 ms^{1/2} in a Bristow method such that a time from the application of the reaction liquid to the recording medium to the application of the aqueous ink to the recording medium is 1800 ms or shorter and such that an ink jet type ejection head and the recording medium are relatively scanned once,
wherein the reaction liquid contains a surfactant,
the surfactant includes at least two types of nonionic surfactants each having an HLB value of 4 or greater and 16 or less,
a difference between a highest HLB value and a lowest HLB value of the at least two types of nonionic surfactants is 1 or greater,
the aqueous ink contains resin particles, and
a difference γᵢ−γᵣ between a surface tension γᵢ of the aqueous ink and a surface tension γᵣ of the reaction liquid at 25° C. is 9 mN/m or less.

2. The ink jet recording method according to claim 1,
wherein the surface tension γᵣ of the reaction liquid at 25° C. is 30 mN/m or less.

3. The ink jet recording method according to claim 1,
wherein the surface tension γᵢ of the aqueous ink at 25° C. is 28 mN/m or less.

4. The ink jet recording method according to claim 1,
wherein the at least two types of nonionic surfactants include a silicone-based surfactant and a hydrocarbon-based surfactant.

5. The ink jet recording method according to claim 1,
wherein the at least two types of nonionic surfactants each have an HLB value of 8 or greater and 16 or less.

6. The ink jet recording method according to claim 1,
wherein the at least two types of nonionic surfactants includes a first type of nonionic surfactant and a second type of nonionic surfactant, and
wherein a mass ratio of a content of the first type of nonionic surfactant to a content of the second type of nonionic surfactant in the reaction liquid is 1/5 or greater and 5/1 or less.

7. The ink jet recording method according to claim 1,
wherein a liquid obtained by replacing the surfactant in the reaction liquid with water at 25° C. has a surface tension of 60 mN/m or greater.

8. The ink jet recording method according to claim 1,
wherein the difference γᵢ−γᵣ between the surface tension γᵢ of the aqueous ink and the surface tension γᵣ of the reaction liquid at 25° C. is 5 mN/m or less.

9. The ink jet recording method according to claim 1,
wherein the aqueous ink further contains a pigment, and
a mass ratio of a content of the resin particles in units of % by mass to a content of the pigment in units of % by mass in the aqueous ink is 1.5 times or greater.

10. The ink jet recording method according to claim 1,
wherein the time from the application of the reaction liquid to the recording medium to the application of the aqueous ink to the recording medium is 50 ms or longer.

11. The ink jet recording method according to claim 1,
wherein the time from the application of the reaction liquid to the recording medium to the application of the aqueous ink to the recording medium is 500 ms or shorter.

12. The ink jet recording method according to claim 1,
wherein particles in a mixed liquid obtained by mixing the aqueous reaction liquid and the aqueous ink at a mass ratio of 1:1 have an average particle diameter of 7 μm or greater.

13. The ink jet recording method according to claim 1,
wherein particles in a mixed liquid obtained by mixing the aqueous reaction liquid and the aqueous ink at a mass ratio of 1:1 have an average particle diameter of 15 μm or greater and 40 μm or less.

14. An ink jet recording apparatus which is used for an ink jet recording method including
recording an image by performing application of an aqueous ink and an aqueous reaction liquid containing a reactant that reacts with the aqueous ink to a unit area of a recording medium having a water absorption amount of 10 mL/m² or less from a start of contact to 30 ms^{1/2} in a Bristow method such that a time from the application of the reaction liquid to the recording medium to the application of the aqueous ink to the recording medium is 1800 ms or shorter and such that an ink jet type ejection head and the recording medium are relatively scanned once,
wherein the reaction liquid contains a surfactant,
the surfactant includes at least two types of nonionic surfactants each having an HLB value of 4 or greater and 16 or less,
a difference between a highest HLB value and a lowest HLB value of the at least two types of nonionic surfactants is 1 or greater,
the aqueous ink contains resin particles, and
a difference γᵢ−γᵣ between a surface tension γᵢ of the aqueous ink and a surface tension γᵣ of the reaction liquid at 25° C. is 9 mN/m or less.

15. A set of an aqueous ink and an aqueous reaction liquid which is used for an ink jet recording method including
recording an image by performing application of the aqueous ink and the aqueous reaction liquid containing a reactant that reacts with the aqueous ink to a unit area of a recording medium having a water absorption amount of 10 mL/m² or less from a start of contact to 30 ms^{1/2} in a Bristow method such that a time from the application of the reaction liquid to the recording medium to the application of the aqueous ink to the recording medium is 1800 ms or shorter and such that an ink jet type ejection head and the recording medium are relatively scanned once,
wherein the reaction liquid contains a surfactant,
the surfactant includes at least two types of nonionic surfactants having an HLB value of 4 or greater and 16 or less,
a difference between a highest HLB value and a lowest HLB value of the at least two types of nonionic surfactants is 1 or greater,
the aqueous ink contains resin particles, and
a difference γᵢ−γᵣ between a surface tension γᵢ of the aqueous ink and a surface tension γᵣ of the reaction liquid at 25° C. is 9 mN/m or less.
